(19) United States
(12) Patent Application Publication
(10) Pub. No.: US 2019/0041818 A1
(43) Pub. Date: Feb. 7, 2019

(54) COMMUNICATION SYSTEM AND COMMUNICATION METHOD

(71) Applicant: FUJITSU LIMITED, Kawasaki-shi (JP)

(72) Inventors: Mitsuru Tomono, Higashimurayama (JP); Takuya Sato, Yokohama (JP); Takahiro Notsu, Kawasaki (JP); Makoto Mori, Kawasaki (JP)

(73) Assignee: FUJITSU LIMITED, Kawasaki-shi (JP)

(21) Appl. No.: 16/144,224

(22) Filed: Sep. 27, 2018

Related U.S. Application Data
(63) Continuation of application No. PCT/JP2016/060929, filed on Apr. 1, 2016.

(51) Int. Cl. G05B 19/048; H04N 7/18; G05B 19/04; H04L 9/08; H04L 12/28

(52) U.S. Cl. CPC G05B 19/048; H04N 7/181; G05B 2219/2642; H04L 9/0816; H04L 12/2816; G05B 19/041

(57) ABSTRACT

A communication system includes a first device including a first memory for storing first data, and a processor configured to generate second data according to the first data and store the second data in a second memory; a second device including a processor configured to transmit the second data, stored in the second memory to a first server; and a control device including a processor configured to exclusively turn on the first device and the second device.

### CROSS-REFERENCE TO RELATED APPLICATION

This application is a continuation application of International Application PCT/JP2016/060929 filed on Apr. 1, 2016 and designated the U.S., the entire contents of which are incorporated herein by reference.

### FIELD

The present disclosure relates to a communication system and a communication method.

### BACKGROUND

At present, various appliances may be connected to a network. There is also a system in which a server computer communicates with an appliance connected to a network and remotely controls the appliance. As an example of such a system, a connected home system (sometimes referred to as smart home as well) has been conceived.

The connected home system automatically controls energy supplied into a home and appliances in the home and realizes a more comfortable house, In the connected home system, in a house, in some case, information indicating where a user is and what the user is doing is detected by a sensor that senses light, sound, heat, and the like and the detected information is transmitted to a server computer on a network. The server computer may control the appliances in the home based on the received information.

Incidentally, as data input to the system as explained above, highly confidential data such as information related to privacy of the user is also present. Therefore, a method for protecting highly confidential important data has been conceived.

For example, there is a proposal of a security camera including a network camera and a network switch that connects the network camera and a public network connection device provided on the outside. In this proposal, a switch is provided between a voltage source, which supplies an internal power supply voltage to the network switch, and the network switch. The switch switches, based on a switch control signal input from the outside, shutoff or supply of the internal power supply voltage supplied to the network switch.

There is also a proposal for, in a remote monitoring system in which an IP (Internet Protocol) network is used, encrypting images output from a network camera device to thereby improve security of important images not desired to be leaked to the outside.

Examples of related-art documents are Japanese Laid-open Patent Publication Nos. 2010-161463 and 2003-125326

### SUMMARY

In one aspect of the embodiments, a communication system includes a first device including a first memory for storing first data, and a processor configured to, generate second data according to the first data and store the second data in a second memory; a second device including a processor configured to transmit the second data stored in the second memory to a first server; and a control device including a processor configured to exclusively turn on the first device and the second device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a communication system in a first embodiment;

FIG. 2 is a diagram illustrating a communication system in a second embodiment;

FIG. 3 is a diagram illustrating an example of a connected home system in a third embodiment;

FIG. 4 is a diagram illustrating a hardware example of a sensor device in the third embodiment;

FIG. 5 is a diagram illustrating an example of a power supply unit of the sensor device in the third embodiment;

FIG. 6 is a diagram illustrating a hardware example of a home server in the third embodiment;

FIG. 7 is a diagram illustrating a hardware example of a household electric appliance in the third embodiment;

FIG. 8 is a diagram illustrating a function example of the home server in the third embodiment;

FIG. 9 is a diagram illustrating a function example of a central server in the third embodiment;

FIG. 10 is a diagram illustrating an example of context conversion table in the third embodiment;

FIG. 11 is a sequence chart illustrating a power supply control example in the third embodiment;

FIG. 12 is a flowchart illustrating an example of appliance control in the third embodiment;

FIG. 13 is a flowchart illustrating another example of the appliance control in the third embodiment;

FIG. 14 is a diagram illustrating another example of the power supply unit of the sensor device in the third embodiment;

FIG. 15 is a diagram illustrating a hardware example of sensor device in a fourth embodiment;

FIG. 16 is a diagram illustrating a function example of a central server in the fourth embodiment;

FIG. 17 is a flowchart illustrating an example of appliance control in the fourth embodiment;

FIG. 18 is a diagram illustrating a function example of a central server in a fifth embodiment;

FIG. 19 is a diagram illustrating a function example of a home server in the fifth embodiment;

FIG. 20 is a diagram illustrating an example of an intermediate context conversion table in the fifth embodiment;

FIG. 21 is a flowchart illustrating an example of appliance control in the fifth embodiment;

FIG. 22 is a diagram illustrating a hardware example of a sensor device in a sixth embodiment;

FIG. 23 is a flowchart illustrating an example of appliance control in the sixth embodiment;

FIG. 24 is a diagram illustrating an example of a power supply unit of a sensor device in a seventh embodiment;

FIG. 25 is a flowchart illustrating an example of appliance control in the seventh embodiment;

FIG. 26 is a diagram illustrating are example of a power supply unit of a sensor device in an eighth embodiment;

FIG. 27 is a diagram illustrating a hardware example in a ninth embodiment; and

FIG. 28 is a diagram illustrating a hardware example of sensor device in a tenth embodiment.

### DESCRIPTION OF EMBODIMENTS

For example, a system that performs communication between devices in order to perform monitoring, remote control of appliances, and the like is conceivable. In such a system, information leakage due to an illegal access to a device carrying out a function of communication with other appliances is a problem. For example, when a device for communication receives an illegal access, it is likely that important data (for example, data related to privacy of users) retained by other devices inside the system is accessed via the device.

As in the proposal explained above, it is also conceivable that the user manually operates the physical switch to switch shutoff or supply of the internal power supply voltage supplied to the network switch. However, when an illegal access is received during the power supply to the network switch, it is likely that the data inside the system is eventually accessed and the data leaks unless the user operates the switch.

Embodiments are explained below with reference to the drawings.

### First Embodiment

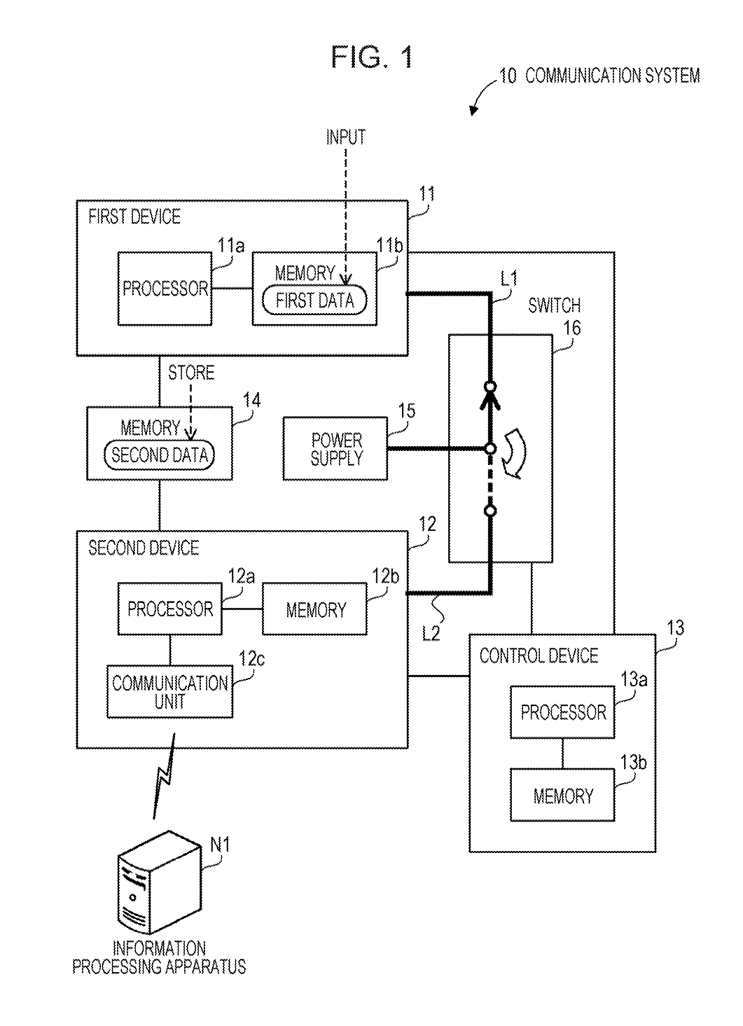

FIG. 1 is a diagram illustrating a communication system in a first embodiment. A communication system 10 includes a first device 11, a second device 12, a control device 13, a memory 14, a power supply 15, and a switch 16.

The first device 1 includes a processor 11a and a memory 11b. The processor 11a is an arithmetic device of the first device 11. The processor 11a may include an FPGA (Field Programmable Gate Array), a DSP (Digital Signal Processor), an ASIC (Application Specific Integrated Circuit), and a CPU (Central Processing Unit). The processor 11a may be a general-purpose processor that executes a program. The processor 11a may include a set of a plurality of processors (a multiprocessor) as well. The memory 11b may be a volatile storage device such as a RAM (Random-Access Memory) or may be a nonvolatile storage device such as a flash memory. The memory 11b may be referred to as first memory as well and the memory 14 may be referred to as second memory as well.

The second device 12 includes a processor 12a, a memory 12b, and a communication unit 12c, The control device 13 includes a processor 13a and a memory 13b. The processors 12a and 13a are the same arithmetic devices as the processor 11a. However, a function of the control device 13 is realized by a hard-wired logic (for security, desirably, posterior rewriting of a logic is unable to be performed (the control device 13 is not programmable)). For example, it is conceivable to use, as the processor 13a, an FPGA in which logic data is written in a one-time flash in a manufacturing site such as a factory. The memories 12b and 13b are the same storage devices as the memory 11b. The communication unit 12c is a communication interface that communicates with an information processing device N1. The communication unit 12c may be a communication interface for wireless communication or may be a communication interface for wired communication.

The memory 14 is a storage device provided separately from the first device 11, the second device 12, and the control device 13. The memory 14 may be a volatile storage device such as a RAM or may be a nonvolatile storage device such as a flash memory.

The power supply 15 supplies electric power to the first device 11, the second device 12, the control device 13, and the memory 14 (however, in FIG. 1, illustration of power supply lines to the control device 13 and the memory 14 is omitted). The power supply 15 may be a power supply unit that converts an alternating current supplied from a commercial power supply into a direct current and distributes the direct current to units or may be a battery. A power supply line L1 is a wire for supplying electric power from the power supply 15 to the first device 11. A power supply line L2 is a wire for supplying electric power from the power supply 15 to the second device 12.

The switch 16 switches, concerning the first device 11 and the second device 12, a power supply destination by the power supply 15 to one of the first device 11 and the second device 12 (that is, connects one of the power supply lines L1 and L2 and disconnects the other). The switch 16 is controlled by the control device 13. Note that devices selectable as the power supply destination of the power supply 15 are the first device 11 and the second device 12. The control device 13 and the memory 14 are usually pow r supply destinations from the power supply 15.

In an example in the first embodiment, the first device 11, the control device 13, the memory 14, the power supply 15, and the switch 16 do not include communication interfaces that communicate with the information processing device N1.

The processor 11a stores first data input to the first device 11 in the memory 11b. First data may be, for example, sensor data generated by a sensor device observing a physical phenomenon (light, heat, sound, and the like) around the sensor device. The sensor device may be a sensor device that detects presence of a person with, for example, an infrared ray, ultrasound, or visible light. The sensor data may be, for example, image data, sound data, and heat data generated by the sensor device detecting light, sound, heat, and the like around the sensor device. Note that the first device 11 may be a part of the sensor device. The communication system 10 may be incorporated in the sensor device.

The processor 11a generates second data according to the first data stored in the memory 11b and stores the second data in the memory 14. For example, the second data may be analysis result data representing a result obtained by performing a predetermined analysis on the first data. The second data may be context data used for determination of control content of the communication system 10 or other devices.

The processor 12a acquires the second data stored in the memory 14 and stores the second data in the memory 12b. The processor 12a transmits the second data stored in the memory 12b to the information processing device N1 via the communication unit 12c. The information processing device N1 may control, according to the second data, an electronic device connected to a network to which the information processing device N1 belongs. The processor 12a sometimes receives data from the information processing device N1 via the communication unit 12c.

The processor 13a exclusively turns on the first device 11 and the second device 12. That is, when the first device 11 is turned on, the second device 12 is turned off. When the second device 12 is turned on, the first device 11 is turned off.

The processor 13a may switch the turn-on/off of the first device 1 and the second device 12 at timing corresponding to an instruction from the first device 11 or the second device 12. For example, the processor 13a may perform the turn-off of the first device 11 and the turn-on of the second device 12 after receiving, from the first device 11, a notification to the effect that the generation of the second data and the storage of the second data in the memo 14 by the first device 11 are completed. For example, the processor 13a may perform the turn-off of the second device 12 and the turn-on of the first device 11 after receiving, from the second device 12, a notification to the effect that the transmission of the second data by the second device 12 is completed.

It is conceivable that the processor 13a controls the turn-on/off of the first device 11 and the second device 12 as explained below. For example, the processor 13a operates the switch 16 to select whether to set a supply destination of electric power by the power supply 15 to the first device 11 or the second device 12. The processor 13a may store, in the memory 13b, information indicating present states of the turn-on/off of the first device 11 and the second device 12.

For example, the processor 1 a operates the switch 16 to connect the power supply 15 and the first device 11 through the power supply line L1. Then, the first device 11 is turned on. At this time, the processor 13a disconnects the power supply line L2. Then, the second device 12 is turned off. Consequently, the first device 11 may perform, for example, processing for generating the second data from the first data. On the other hand, because the second device 12 is turned off, the communication system 10 comes into a state in which communication with the information processing device N1 using the second device 12 is unable to, be performed.

The processor 13a operates the switch 16 to connect the power supply 15 and the second device 12 through the power supply line L2. Then, the second device 12 is turned on. At this time, the processor 13a disconnects the power supply line L1. Then, the first device 11 is turned off. Consequently, the second device 12 may perform, for example, processing for transmitting the second data to the information processing device N1. On the other hand, because the first device 11 is turned off, the communication system 10 comes into a state in which an access to the first device 11 is unable to be performed.

In this way, with the communication system 10 in the first embodiment, leakage of the first data may be stopped. A system connected to a network (a connected home system or the like) to perform, for example, monitoring and remote control of appliances is conceivable. In such a system, information leakage due to an illegal access to a device (for example, the second device 12) carrying out a communication function is a problem. For example, when a device (for communication) carrying out a communication function receives an illegal access, it is likely that important data (for example, the first data) retained by another device (for example, the first device 11) inside the system is accessed using the device as a stepping-stone.

Therefore, in the communication system 10, the first device 11 and the second device 12 are exclusively turned on by the control device 13. Then, first, while the first device 11 generates the second data based on the first data, communication using the second device 12 is impossible. That is, an access from the information processing device N1 to the second device 12 is unable to be performed either, Therefore, an illegal access to the second device 12 may be stopped. Accordingly, an illegal access to the first data and leakage of the first data during processing in the first device 11 may be stopped.

Second, the first device 11 is unable to be accessed while the second device 12 transmits the second data. Therefore, even if the second device 12 receives an illegal access, an illegal access to data stored in the memory 11b of the first device 11 may be stopped. Accordingly, leakage of the first data retained by the first device 11 may be stopped. When the memory 11b is a volatile storage device, because the first data may be erased from the memory 11b by the turn-off of the first device 11, leakage of the first data may be further reduced.

In particular, when data concerning privacy such as, sensor data for a user living in a house is input to the communication system 10, appropriate protection of data is requested. This is because, if a life style and the like of the user are known by an outsider, privacy of the user is infringed. It is also likely that data concerning an individual reflected in an image or the like leaks and is illegally used by an outsider. With the communication system 10, even when such important data concerning the individual is input, the input data may be appropriately protected.

Note that the first device 11, the second device 12, the control device 13, the memory 14, the power supply 15, and the switch 16 may be incorporated in a System on a Chip (SoC). The SoC represents one semiconductor chip implemented with functions by a plurality of devices. Alternatively, the SoC is sometimes used as a term indicating a method of implementing functions by a plurality of devices on one semiconductor chip. Then, an expression “incorporated in the SoC” is synonymous with an expression “incorporated on one semiconductor using the method of the SoC”. That is, the communication system 10 illustrated in FIG. 1 may be incorporated and implemented on one semiconductor chip. However, the SoC may not include the first device 11. Alternatively, the first device 11, the second device 12, the control device 13, the memory 14, the power supply 15, the switch 16 may be implemented by a System in a Package (Sip). However, the SiP may not include the first device 11. By implementing these devices with the SoC or the SiP, marketability of a system product implemented with the functions illustrated in the first embodiment may be improved. The system product may be easily incorporated in the sensor device or the like and used.

### Second Embodiment

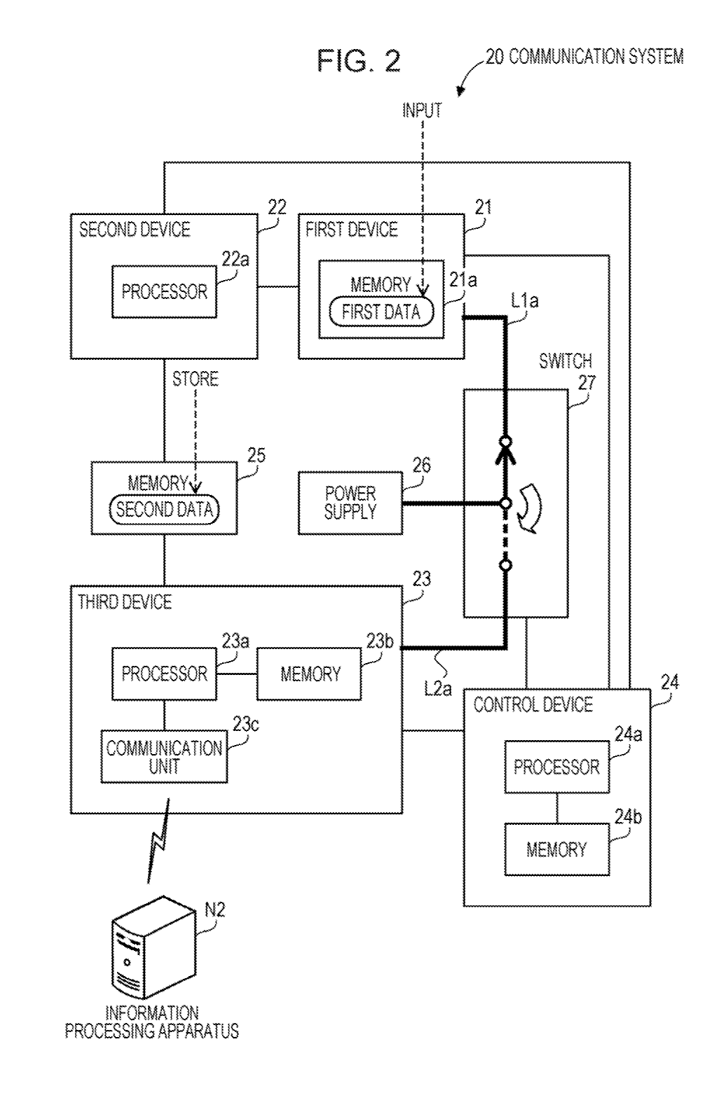

FIG. 2 is a diagram illustrating a communication system in a second embodiment. Matters different from the matters in the first embodiment explained above are mainly explained. Explanation of matters common to the first embodiment is omitted.

A communication system 20 includes a first device 21, a second device 22, a third device 23, a control device 24, a memory 25, a power supply 26, and a switch 27. The first device 21 includes a memory 21a. The memory 21a may be a volatile storage device such as a RAM or may be a nonvolatile storage device such as a flash memory. The memory 21a may be referred to as first memory as well and the memory 25 may be referred to as second memory as well.

The second device 22 includes a processor 22a, The processor 22a is the same arithmetic device as the processor 11a. The third device 23 includes a processor 23a, a memory 23b, and a communication unit 23c. The control device 24 includes a processor 24a and a memory 24b. The processors 23a and 24a are the same arithmetic devices as the processor 11a. The memories 23b and 24b are the same storage devices as the memory 11b. The communication unit 23c is a communication interface that communicates with an information processing device N2. The communication unit 23c may be a communication interface for wireless communication or may be a communication interface for wired communication.

The memory 25 is a storage device provided separately from the first device 21, the second device 22, the third device 23, and the control device 24. The memory 25 may be a volatile storage device such as a RAM or may be a nonvolatile storage device such as a flash memory.

The power supply 26 supplies electric power to the fret device 21, the second device 22, the third device 23, the control device 24, and the memory 25 (however, in FIG. 2, illustration of power supply lines to the second device 22, the control device 24, and the memory 25 is omitted). The power supply 26 may be a power supply unit that converts an alternating current supplied from a commercial power supply into a direct current and distributes the direct current to units or may be a battery. A power supply line L1a is a wire for supplying electric power from the power supply 26 to the first device 21. A power supply line L2a is, a wire for supplying electric power from the power supply 15 to the third device 23.

The switch 27 switches, concerning the first device 21 and the third device 23, a power supply destination of the power supply 26 to one of the first device 21 and the third device 23 (that is, connects one of the power supply lines L1a and L2aand disconnects the other). The switch 27 is controlled by the control device 24. Note that devices selectable as the power supply destination of the power supply 26 are the first device 21 and the third device 23. The second device 22, the control device 24, and the memory 25 are usually power supply destinations of the power supply 26.

In an example in the second embodiment, the first device 21, the second device 22, the control device 24, the memory 25, the power supply 26, and the switch 27 do not include communication interfaces that communicate with the information processing device N2.

The processor 22a stores first data input to the communication system 20 in the memory 21a. First data may be, for example, sensor data generated by a sensor device observing a physical phenomenon around the sensor device. The sensor device may be a sensor device that detects presence of a person with, for example, an infrared ray, ultrasound, or visible light. The sensor data may be, for example, image data, sound data, and heat data generated by the sensor device detecting light, sound, heat, and the like around the sensor device. Note that the first device 21 and the second device 22 may be a part of the sensor device. The communication system 20 may be incorporated in the sensor device.

The processor 22a generates second data according to the first data stored in the memory 21a and stores the second data in the memory 25. For example, the second data may be analysis result data representing a result obtained by performing a predetermined analysis on the first data. The second data may be context data used for determination of control content of the communication system 20 or other devices.

The processor 23a acquires the second data stored in the memory 25 and stores the second data in the memory 23b. The processor 23a transmits the second data stored in the memory 23b to the information processing device N2 via the communication unit 23c. The information processing device N2 may control, according to the second data, an electronic device connected to a network to which the information processing device N2 belongs. The processor 23a sometimes receives data from the information processing device N2 via the communication unit 23c.

The processor 24a exclusively turns on the first device 21 and the third device 23. That is, when the first device 21 is turned on, the third device 23 is turned off. When the third device 23 is turned on, the first device 21 is turned off.

The processor 24a may switch the turn-on/off of the first device 21 and the third device 23 at timing corresponding to an instruction from the second device 22 or the third device 23. For example, the processor 24a may perform the turn-off of the first device 21 and the turn-on of the third device 23 after receiving, from the second device 22, a notification to the effect that the generation of the second data and the storage of the second data in the memory 25 by the second device 22 are completed, For example, the processor 24a may perform the turn-off of the third device 23 and the turn-on of the first device 21 after receiving, from the third device 23, a notification to the effect that the transmission of the second data by the third device 23 is completed.

It is conceivable that the processor 24a controls the turn-on/off of the first device 21 and the third device 23 as explained below. For example, the processor 24a operates the switch 27 to select whether to set a supply destination of electric power by the power supply 26 is set as the first device 21 or the third device 3. The processor 24a may store, in the memory 24b, information indicating present, states of the turn-on/off of the first device 21 and the third device 23.

For example, the processor 24a operates the switch 27 to connect the power supply 26 and the first device 21 through the power supply line L1a. Then, the first device 21 is turned on. At this time, the processor 24a disconnects the power supply line L2a. Then, the third device 23 is turned off. consequently, the second device 22 may perform, for example, processing for generating the second data from the first data stored in the first device 21. On the other hand, because the third device 23 is turned off, the communication system 20 is in a state in which communication with the information processing device N2 performed using the third device 23 is unable to be performed.

The processor 24a operates the switch 27 to connect the power supply 26 and the third device 23 through the power supply line L2a. Then, the third device 23 is turned on. At this time, the processor 24a disconnects the power supply line L1a. Then, the first device 21 is turned off. Consequently, the third device 23 may perform, for example, processing for transmitting the second data to the information processing device N2. On the other hand, because the first device 21 is turned, off, the communication system 20 comes into a state in which an access to the first device 21 is unable to be performed.

With the communication system 20 in the second embodiment, leakage of the first data may be stopped as in the communication system 10 in the first embodiment. Specifically, in the communication system 20, the first device 21 and the third device 23 are exclusively turned on by the control device 24,

Then, first, communication using the third device 23 is impossible while the second device 22 generates the second data based on the first data. That is, an access from the information processing device N2 to the third device 23 is unable to be performed either. Therefore, an illegal access to the third device 23 may be stopped. Accordingly, an illegal access to the first device 21 and the second device 22 may be stopped. Leakage of the first data stored in the first device 21 may be stopped.

Second, the first device 21 is unable to be accessed while the third device 23 transmits the second data. Therefore, even if the third device 23 receives an illegal access, an illegal access to data stored in the memory 21a of the first device 21 may be stopped. Accordingly, leakage of the first data stored in the first device 21 may be stopped. When the memory 21a is a volatile storage device, leakage of the first data may be further reduced because the first data is erased from the memory 21a by the turn-off of the first device 21.

In particular, when data concerning privacy such as, sensor data for a user living in a house is input to the communication system 20, appropriate protection of data is requested. This is because, if a life style and the like of the user are known by an outsider, privacy of the user is infringed. It is also likely that data concerning an individual reflected in an image or the like leaks and is illegally used by an outsider. With the communication system 20, even when such important data concerning the individual is input, the input data may be appropriately protected.

Note that the first device 21, the second device 22, the third device 23, the control device 24, the memory 25, the power supply 26, and the switch 27 may be incorporated in an SoC (may be configured by the SoC). That is, the communication system 20 illustrated in FIG. 2 may be implemented on one semiconductor chip. However, the SoC may not include the first device 21. Alternatively, the first device 21, the second device 22, the third device 23, the control device 24, the memory 25, the power supply 26, and the switch 27 may be implemented by an SiC. However, the SiC may not include the first device 21. By implementing these devices with the SoC or the SiC, marketability of a system product implemented with the functions illustrated in the second embodiment may be improved. The system product may be easily incorporated in the sensor device or the like and used.

In the following explanation, a connected home system is illustrated and the functions of the communication systems 10 and 20 explained in the first and second embodiments are more specifically explained.

### Third Embodiment

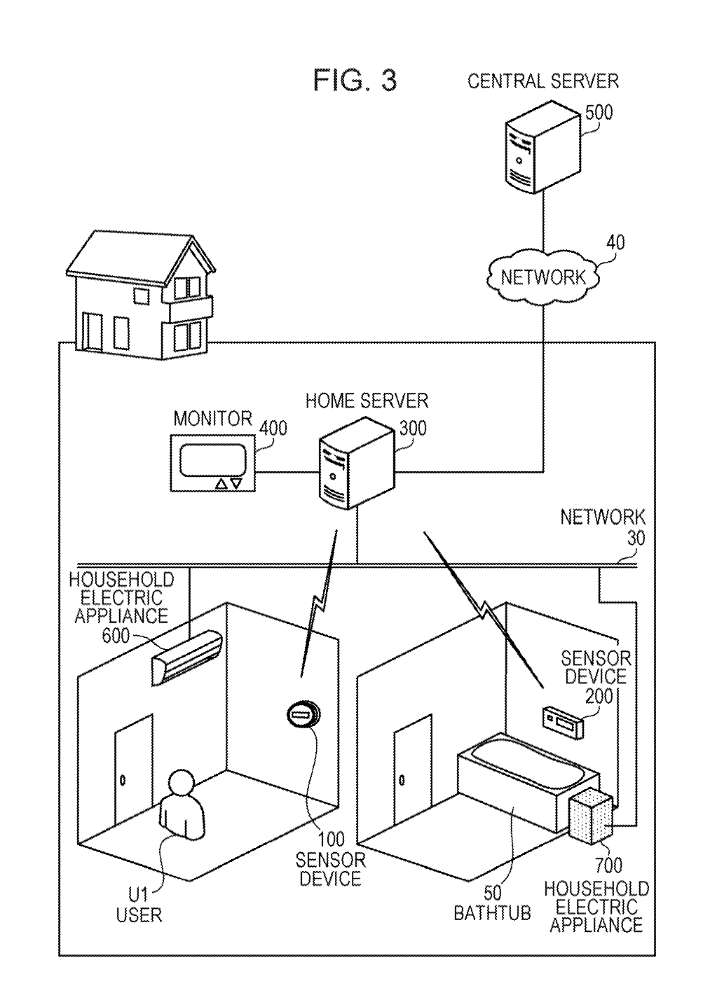

FIG. 3 is a diagram illustrating a connected home system in a third embodiment. The connected home system in the third embodiment is a system that remotely controls, according to a state of a user U1, electronic devices provided in a house where the user U1 lives. The connected home system in the third embodiment includes sensor devices 100 and 200, a home server 300, a monitor 400, a central server 500, and household electric appliances 600 and 700.

The home server 300 and the household electric appliances 600 and 700 are connected to a network 30. The network 30 is, for example, a LAN (Local Area Network) provided in a house. The home server 300 and the central server 500 are connected to a network 40. The network 40 is, for example, the Internet or a WAN (Wide Area Network).

The sensor devices 100 and 200 are sensors provided in rooms in the house. The sensor devices 100 and 200 are communicable with the home server 300 by radio. As a technique of wireless communication, for example, Bluetooth (registered trademark) or a Bluetooth LE (Low Energy) may be used. A communication band between the sensor devices 100 and 200 and the home server 300 is a communication band narrower than a communication band of the network 30 (the communication band may be a minimum band in which local context data explained below may be transferred within a practical allowable time).

For example, the sensor device 100 is provided in a living room. Sensor data generated by the sensor device 100 is used for operation control of the household electric appliance 600 and the like provided in the living room. The sensor device 200 is provided in a bathroom. Sensor data generated by the sensor device 200 is used for operation control of the household electric appliance 700 and the like provided on the outer side of the bathroom.

The sensor devices 100 and 200 generate local context data based on the sensor data. The local context data is data used by the central server 500 in order to determine control content of an electronic appliance in the house. The local context data is data having a small size compared with the sensor data. The size of the local context data is, for example approximately 8 bits or 16 bits. The sensor devices 100 and 200 transmit the local context data to the home server 300. The sensor data is an example of the first data in the first embodiment. The local context data is an example of the second data in the first embodiment.

The home server 300 is a server computer set in the house. The home server 300 receives the local context data from the sensor devices 100 and 200. As explained above, the communication band between the sensor devices 100 and 200 and the home server 300 is sufficient for the transmission of the local context data but is limited to a degree in which sensor data including a moving image and the like is unable to be transmitted in a relatively short time. The home server 300 adds user information and the like to the received local context data and transmits the user information and the like to the central server 500.

The home server 300 receives global context data from the central server 500. The global context data is data generated by the central server 500 according to the local context data and is information equivalent to control content of an electronic appliance in the home. The home server 300 controls, based on the global context data, display content of the monitor 400 and the operation of the household electric appliances 600 and 700. The home server 300 is an example of the information processing device N1 (the first information processing device) in the first embodiment.

The monitor 400 is a display device set in the house. For example, the user U1 may confirm content displayed by the monitor 400 and grasp operation states of the household electric appliance 600 and the household electric appliance 700.

The central server 500 generates global context data based on the local context data and transmits the global context data to the home server 300. In the connected home system in the third embodiment, on the central server 500 side where a secure environment may be kept, the local context data is converted into the global context data and provided to the home server 300. This is to make it impossible to easily estimate only from the local context data how an electronic appliance in the house is controlled with respect to the local context data. The central server 500 may be referred to as second information processing device as well.

The household electric, appliances 600 and 700 are electronic appliances set in the house. The household electric appliance 600 is, for example, an air conditioner. The household electric appliance 600 adjusts temperature and humidity in the living room. The household electric appliance 700 is, for example, a water heater. The household electric appliance 700 adjusts an amount of water stored in a bathtub 50 provided in the bathroom and temperature of hot water. The household electric appliances 600 and 700 illustrated in FIG. 3 are examples. As control targets of the connected home system, besides the household electric appliances 600 and 700, various electronic appliances (for example, a luminaire, floor heating, a ventilating fan, a refrigerator, an electric shutter, an electronic lock, and an electromagnetic cooker) are conceivable.

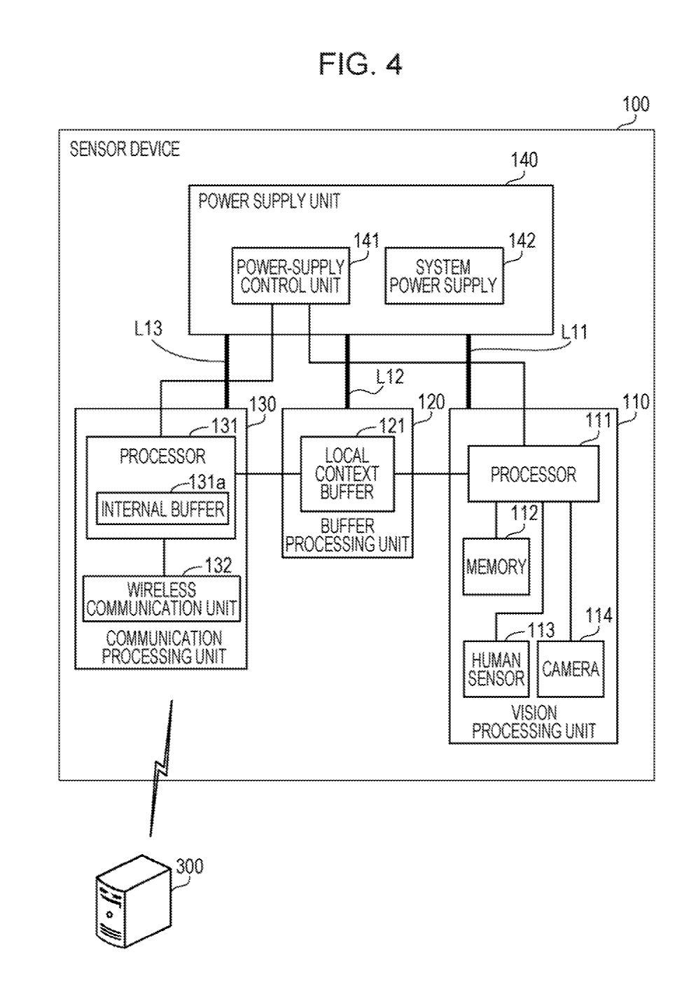

FIG. 4 is a diagram illustrating a hardware example of a sensor device in the third embodiment. The sensor device 100 includes a vision processing unit 110, a buffer processing unit 120, a communication processing unit 130, and a power supply unit 140.

The vision processing unit 110 is a device that executes vision processing. The vision processing is processing, for analyzing sensor data and acquiring local context data. The sensor data is, for example, image data generated by a sensor detecting light around the sensor, However, sensor data may be sound data, heat data, and the like generated by detecting sound, heat, and the like. The vision processing unit 110 includes a processor 111, a memory 112, a human sensor 113, and a camera 114.

The processor 111 is an arithmetic device that controls information processing of the vision, processing unit 110. The processor 111 is, for example, a CPU, a DSP, an ASIC, or an FPGA. The processor 111 may be a combination of two or more elements among the CPU, the DSP, the ASIC, the FPGA, and the like.

The processor 111 generates local context data based on image data generated by the camera 114. The processor 111 outputs the generated focal context data to the buffer processing unit 120.

The memory 112 is a storage device that stores data used for processing of the processor 111. The memory 112 may be a volatile storage device or may be a nonvolatile storage device. Note that, when the memory 112 is a volatile storage device and the processor 111 executes a predetermined program, the vision processing unit 110 may include, in addition to the memory 112, a nonvolatile storage device such as a flash memory that stores the program.

The human sensor 113 detects, with an infrared ray, presence of the user U1 in the living room and outputs a result of the detection to the processor 111. The camera 114 photographs the inside of the living room with visible light to generate image data and outputs the image data to the processor 111 according to an instruction of the processor 111.

The buffer processing unit 120 is a buffer provided between the vision processing, unit 110 and the communication processing unit 130. The buffer processing unit 120 includes a local context buffer 121. The buffer processing unit 120 stores the local context data output by the vision processing unit 110 in the local context buffer 121. The buffer processing unit 120 outputs the local context data stored in the local context buffer 121 to the communication processing unit 130. The local context buffer 121 is a buffer memory for storing the local context data. The local context buffer 121 only has to at least have a storage capacity enough for storing the local context data (if a size of the local context data is 16 bits, a size of the local context buffer 121 is also approximately 16 bits). This is to limit transmission of data having a relatively large size such as moving image data.

The communication processing unit 130 performs data communication with the home server 300. The communication processing unit 130 includes a processor 131 and a wireless communication unit 132. The processor 131 is, for example, a CPU, a DSP, an ASIC, or an FPGA. The processor 131 may be a combination of two or more elements among the CPU, the DSP, the ASIC, the FPGA, and the like. The processor 131 includes an internal buffer 131a. The internal buffer 131a is a storage device that temporarily stores transmission target data. The processor 131 stores the local context data acquired from the buffer processing unit 120 in the internal buffer 131a and transmits the local context data to the home server 300 using the wireless communication unit 132.

The wireless communication unit 132 is a wireless communication interface (for example, an interface of the Bluetooth) that communicates with the home server 300 by radio. The power supply unit 140 supplies electric power respectively to the vision processing unit 110, the buffer processing unit 120, and the communication processing unit 130. A power supply line L11 is a wire for supplying electric power to the vision processing unit 110. A power supply line L12 is a wire for supplying electric power to the buffer processing unit 120. A power supply line L13 is a wire for supplying electric power to the communication processing unit 130. The power supply unit 140 includes a power-supply control unit 141 and a system power supply 142.

The power-supply control unit 141 is realized by a processor such as an FPGA or an ASIC, for example. The power-supply control unit 141 communicates with the processors 111 and 131 via an internal bus and controls turn-on/off of the vision processing unit 110 and the communication processing unit 130. The power-supply control unit 141 exclusively turns on the vision processing unit 110 and the communication processing unit 130. That is, when turning on the vision processing unit 110, the power-supply control unit 141 turns off the communication processing unit 130. When turning on the communication processing unit 130, the power-supply control unit 141 turns off the vision processing unit 110.

The power-supply control unit 141 determines, according to predetermined notifications from the vision processing unit 110 and the communication processing unit 130, switching timings for the turn-on/off of the vision, processing unit 110 and the communication processing unit 130. Specifically, when receiving, from the vision processing unit 110, a notification to the effect that a local context is generated and stored in the buffer processing unit 120, the power-supply control unit 141 turns off a power supply of the vision processing unit 110 and turns on a power supply of the communication processing unit 130. When receiving, from the communication processing unit 130, a notification to the effect that transmission of the local context is completed, the power-supply control unit 141 turns off the power supply to the communication processing unit 130 and turns on the power supply to the vision processing unit 110.

The system power supply 42 is a power supply of the sensor device 100. The system power supply 142 generates DC power from an alternating current supplied from a commercial power supply and supplies the DC power to the vision processing unit 110, the buffer processing unit 120, and the communication processing unit 130. The system power supply 142 may be a battery.

The vision processing unit 110 is an example of the first device 11 it the first embodiment. The communication processing unit 130 is an example of the second device 12 in the first embodiment. The power-supply control unit 141 is an example of the control device 13 in the first embodiment. When the sensor device 100 is grasped as an aggregate of a plurality of devices in this way, the sensor device 100 may be considered an example of the communication system 10 in the first embodiment. Alternatively, the connected home system in the third embodiment may be grasped as one system including the sensor device 100. The connected home system in the third embodiment may be considered an example of the communication system 10 in the first embodiment.

Note that the sensor device 100 may include interfaces of a JTAG (Joint Test Action Group) for data writing and debugging for respective registers and the like of the vision processing unit 110, the communication processing unit 130, and the power supply unit 140. In the following explanation, illustration of connecting lines between the power-supply control unit 141 and the vision processing unit 110, the buffer processing unit 120, and the communication processing unit 130 is sometimes omitted.

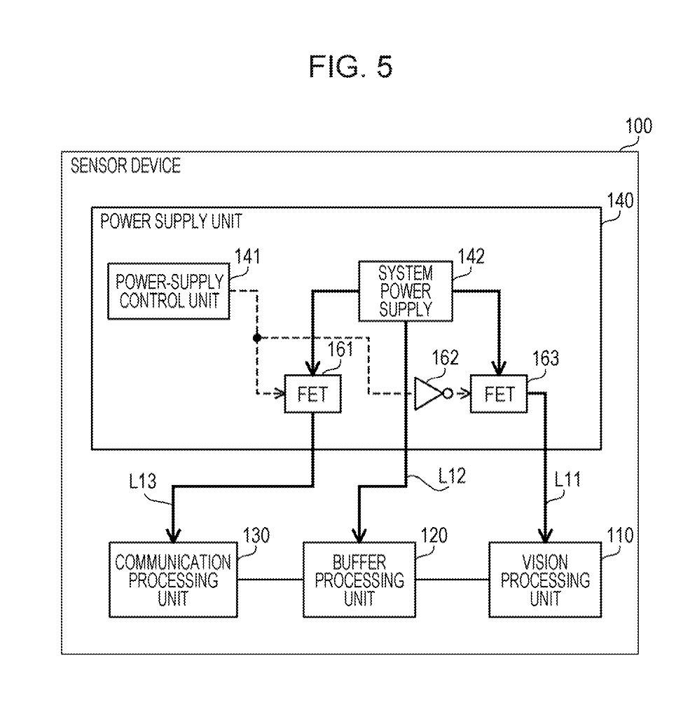

FIG. 5 is a diagram illustrating an example of a power supply unit of the sensor device in the third embodiment. The power supply unit 140 includes field effect transistors (FETs) 161 and 163 and a NOT circuit 162.

The FET 161 is provided on the power supply line L13. A signal (Low or High) from the power-supply control unit 141 is input to the FET 161. When Low is input to the FET 161, electric power is supplied from the system power supply 142 to the communication processing unit 130 through the power supply line L13. When High is input to the FET 161, the power supply line L13 changes to a disconnected state. The power supply from the system power supply 142 to the communication processing unit 130 is interrupted.

The NOT circuit 162 is provided on a signal line that enters the FET 162 from the power-supply control unit 141. The NOT circuit 162 inverts a signal input to the FET 163 from the power-supply control unit 141 such that Low and High are alternately input to the respective FETs 161 and 163. For example, when Low is input to the FET 161 from the power-supply control unit 141, High is input to the FET 163. When High is input to the FET 161 from the power-supply control unit 141, Low is input to the FET 163.

The FET 163 is provided on the power supply line L11. A signal from the power-supply control unit 141 is input to the FET 163. When Low is input to the FET 163, electric power is supplied from the system power supply 142 to the vision processing unit 110 through the power supply line L11. When High is input to the FET 163, the power supply line L11 changes to a disconnected state. The power supply from the system power supply 142 to the vision processing unit 110 is interrupted.

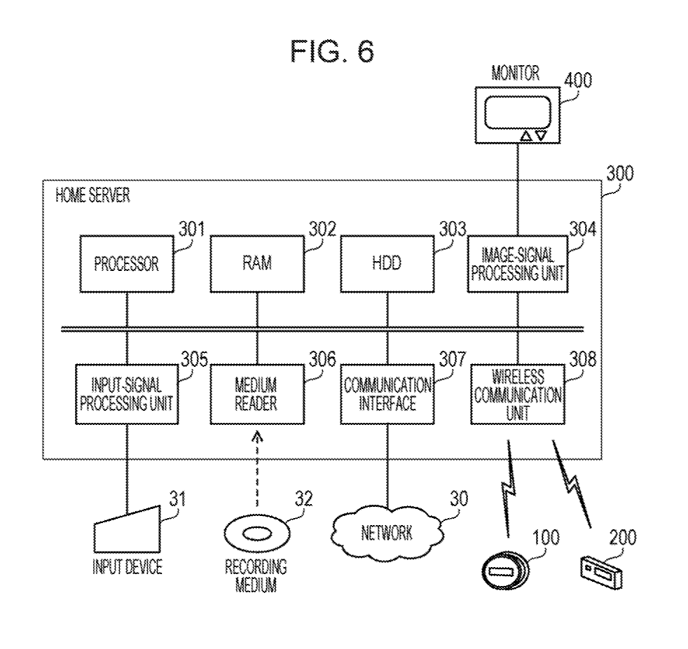

FIG. 6 is a diagram illustrating a hardware example of the home server in the third embodiment. The home server 300 includes a processor 301, a RAM 302, a HDD (Hard Disk Drive) 303, an image-signal processing unit 304, an input-signal processing unit 305, a medium reader 306, a communication interface 307, and a wireless communication unit 308. The units are connected to a bus of the home server 300, Note that the central server 500 may be realized using the same units as the units of the home server 300.

The processor 301 controls information processing of the hone server 300. The processor 301 may be a multiprocessor. The processor 301 is, for example, a CPU, a DSP, an ASIC, or an FPGA. The processor 301 may be a combination of two or more elements among the CPU, the DSP, the ASIC, the FPGA, and the like.

The RAM 302 is a main storage device of the home server 300, The RAM 302 temporarily stores a program of an OS (Operating System) and at least a part of application programs to be executed by the processor 301. The RAM 302 stores various data used for processing by the processor 301.

The HDD 303 is an auxiliary storage device of the home server 300. The HDD 303 magnetically performs writing and readout of data in and from a magnetic disk incorporated in the HDD 303. The HDD 303 stores a program of an OS, application programs, and various data. The home server 300 may include other types of auxiliary storage devices such as a flash memory and an SSD (Solid State Drive) or may include a plurality of auxiliary storage devices.

The image-signal processing unit 304 outputs, according to an instruction from the processor 301, an image to the monitor 400 connected to the home server 300. As the monitor 400, a liquid crystal display or the like may be used.

The input-signal processing unit 305 acquires an input signal from an input device 31 connected to the home server 300 and outputs the input signal to the processor 301. As the input device 31, for example, a pointing device such as a mouse or a touch panel or a keyboard may be used.

The medium reader 306 is a device that reads programs and data recorded in a recording medium 32. As the recording medium 32, for example, magnetic disks such as a flexible disk (FD) and a HDD, optical disks such as a CD (Compact Disc) and a DVD (Digital Versatile Disc), and a magneto-optical disk (MO) may be used. As the recording medium 32, a nonvolatile semiconductor memory such as a flash memory card may also be used. The medium reader 306 stores, for example, according to an instruction from the processor 301, the programs and the data read from the recording medium 32 in the RAM 302 or the HDD 303.

The communication interface 307 performs communication with the household electric appliances 600 and 700 via the network 30. The communication interface 307 may be a wired communication interface or may be a wireless communication interface. Note that the communication interface 307 is connected to the network 40 as well and may communicate with the central server 500 via the network 40. The home server 300 may include, separately from the communication interface 307, another communication interface connected to the network 40.

The wireless communication unit 308 is a wireless communication interface that communicates with the sensor devices 100 and 200 by radio. As explained above, as a technique of the wireless communication, for example, the Bluetooth may be used.

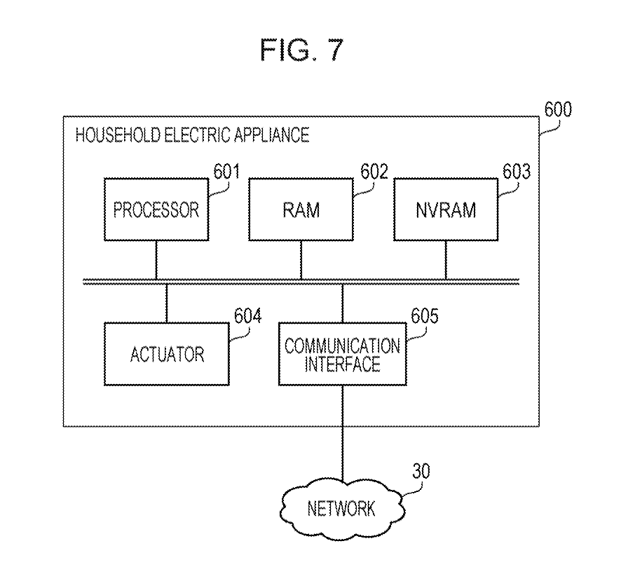

FIG. 7 is a diagram illustrating a hardware example of a household electric appliance in the third embodiment. The household electric appliance 600 includes a processor 601, a RAM 602, an NVRAM (Non-Volatile RAM) 603, an actuator 604, and a communication interface 605.

The processor 601 controls information processing of the household electric appliance 600. The processor 601 may be a multiprocessor. The processor 601 is, for example, a CPU, a DSP, an ASIC, or an FPGA. The processor 601 may be a combination of two or more elements among the CPU, the DSP, the ASIC, the FPGA, and the like.

The RAM 602 is a main storage device of the household electric appliance 600. The RAM 602 temporality stores a program of firmware and at least a part of application programs to be executed by the processor 601. The RAM 602 stores various data used for processing by the processor 601.

The NVRAM 603 is an auxiliary storage device of the household electric appliance 600. The NVRAM 603 stores a program of firmware, application programs, and various data.

The actuator 604 is a driving device of the household electric appliance 600. For example, if the household electric appliance 600 is an air conditioner, the actuator 604 is used for driving of a damper that adjusts an air volume, a change of a wind direction, and the like.

The communication interface 605 performs communication with the home server 300 via the network 30. The communication interface 605 may be a wired communication interface or may be a wireless communication interface.

FIG. 8 is a diagram illustrating a function example of the home server in the third embodiment. The home server 300 includes a storing unit 310, a sensor communication unit 320, a relay unit 330, a communication control unit 340, a global-context processing unit 350, and an appliance communication unit 360. For example, the storing unit 310 is realized using a storage region secured in the RAM 302 or the HDD 303. The sensor communication unit 320, the relay unit 330, the communication control unit 340, the global-context processing unit 350, and the appliance communication unit 360 are realized by the processor 301 executing the programs stored in the RAM 302.

The storing unit 310 stores data used for processing of the relay unit 330 and the global-context processing unit 350. Specifically, the storing unit 310 stores user information of the user U1 (information concerning an account of the user and the like) and a table for converting global context data into commands for the household electric appliances 600 and 700.

The sensor communication unit 320 communicates with the sensor devices 100 and 200 (in FIG. 8, illustration of the sensor device 200 is omitted), The sensor communication unit 320 receives local context data from the sensor devices 100 and 200.

The relay unit 330 performs relay of data to the units of the home server 300. The relay unit 330 adds the user information stored in the storing unit 310 to the local context data received by the sensor communication unit 320, generates communication data, addressed to the central server 500, and sends the communication data to the central server 500 via the communication control unit 340.

When receiving global context data from the central server 500, the relay unit 330 passes the received global context data to the global-context processing unit 350.

The communication control unit 340 communicates with the central server 500 via the network 40. The communication control unit 340 transmits the communication data generated by the relay unit 330 to the central server 500. The communication data includes the local context data and the user information of the user U1. The communication control unit 340 receives the global context data from the central server 500.

The global-context processing unit 350 refers to the table for command conversion stored in the storing unit 310 and converts the global context data into commands for the household electric appliances 600 and 700.

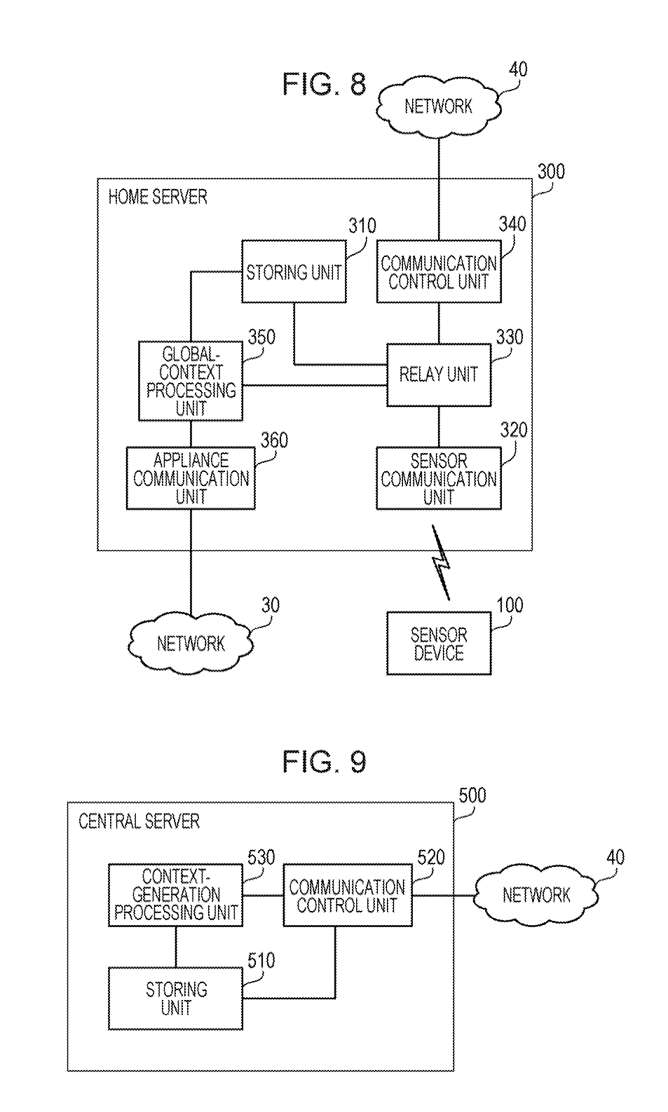

The appliance communication unit 360 receives the command for the household electric appliances 600 and 700 from the global-context processing unit 350 and transmits the commands to the household electric appliances 600 and 700. FIG. 9 is a diagram illustrating a function example of a central server in the third embodiment. The central server 500 includes a storing unit 510, a communication control unit 520, and a context-generation processing unit 530. For example, the storing unit 510 is realized using a storage region secured in a RAM or a HDD included in the central server 500, The communication control unit 520 and the context-generation processing unit 530 are realized by a processor included in the central server 500 executing programs stored in the RAM included in the central server 500.

The storing unit 510 stores a context conversion table, The context conversion table is a table used to convert local context data into global context data. The context conversion table may be considered a list of contents allowed as local context data as well. The context conversion table is provided for each user. For example, the storing unit 510 stores a plurality of context conversion tables for a plurality of users. The respective plurality of context conversion tables are associated with information concerning accounts of the users.

The communication control unit 520 communicates with the home server 300 via the network 40. The communication control unit 520 receives communication data including local context data from the home server 300. The communication control unit 520 transmits global context data generated by the context-generation processing unit 530 to the home server 300.

The context-generation processing unit 530 generates, based on the context conversion table stored in the storing unit 510, global context data corresponding to the received local context data. Specifically, the context-generation processing unit 530 selects, out of the plurality of context conversion tables stored in the storing unit 510, based on user information included in the communication data received this time, a context conversion table corresponding to a relevant user. The context-generation processing unit 530 refers to the select context conversion table and extracts global context data corresponding to the local context data included in the communication data. The context-generation processing unit 530 passes the extracted global context data to the communication control unit 520.

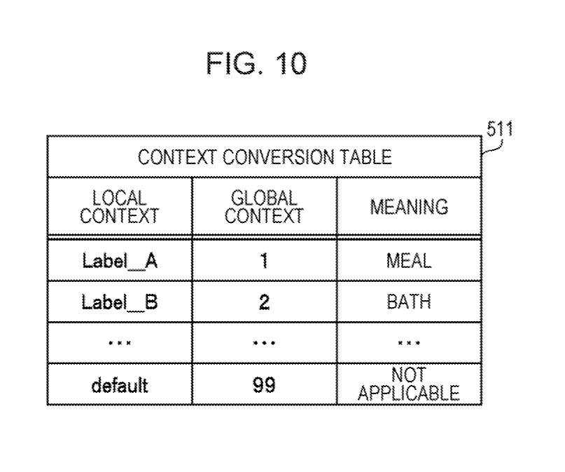

FIG. 10 is a diagram illustrating an example of a context conversion table in the third embodiment. A context conversion table 511 is stored in the storing unit 510 in advance. The context conversion table 511 includes items of a local context, a global context, and a meaning.

In the item of the local context content of local context data is registered. In the item of the global context, content of global context data is registered, In the item of the meaning, a meaning represented by the global context data is registered. Note that the item of the meaning is provided for convenience such that content of the global context data is easily understood. Therefore, the item of the meaning may be removed from the context conversion table 511.

For example, information indicating that the local context is “Label_A”, the global context is “1”, and the meaning is “meal” is registered in the context conversion table 511, This indicates that the global context data is set to “1” when the local context data is “Label_A”. The global context data “1” indicates that the global context data “1” is data indicating that a user is taking a meal.

In the context conversion table 511, the global context data is associated with other local context data as well in the same manner. Note that, in the context conversion table 511, a record in which the local context data is “default” is also registered, This record represents a global context (specifically, “99”) in the case in which received local context data does not correspond to any local context data registered in the context conversion table 511.

A processing procedure of the connected home system in the third embodiment is explained. First, a procedure of exclusive control of the power supply to the vision processing unit 110 and the communication processing unit 130 in the sensor device 100 is explained.

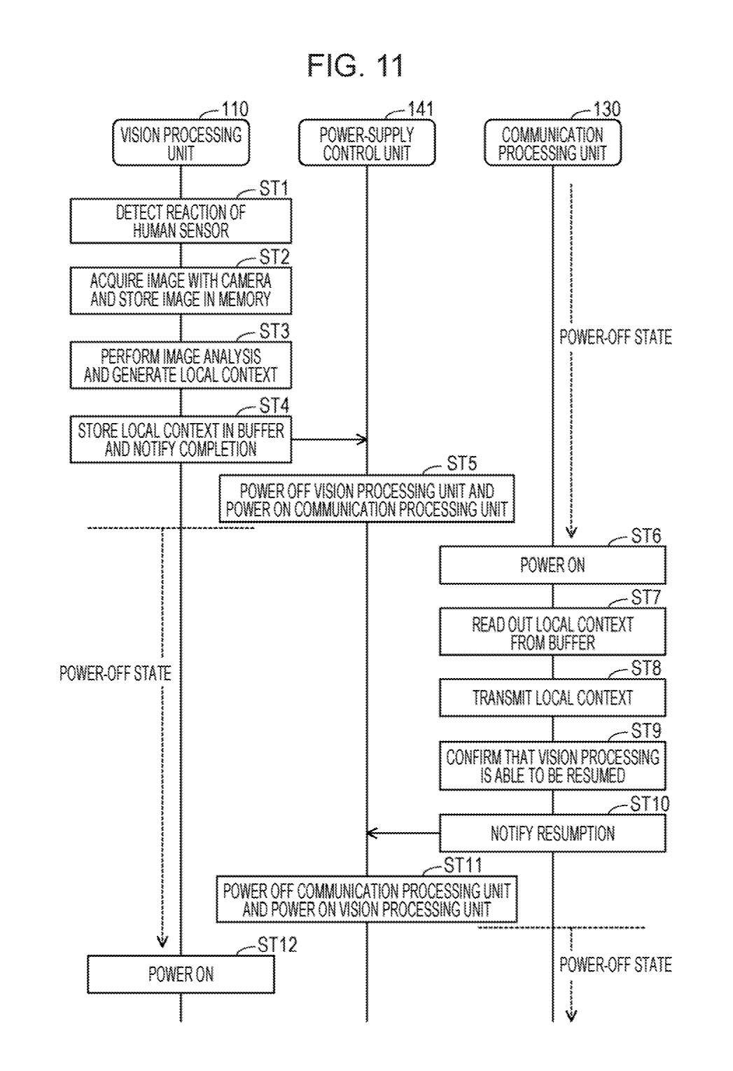

FIG. 11 is a sequence chart illustrating a power supply control example in the third embodiment. Processing illustrated in FIG. 11 is explained below according to step numbers. At a stage when step ST1 explained below is executed, the vision processing unit 110 is in a turned-on state and the communication processing unit 130 is in a turned-off state.

(ST1) The vision processing unit 110 detects reaction of the human sensor 113 to detect presence of the user U1 in the living room. (ST2) The vision processing unit 110 acquires image data with the camera 114 and stores the image data in the memory 112.

(ST3) The vision processing unit 110 performs an analysis of the image data stored in the memory 112 and acquires local context data. An existing method may be used for the analysis of the image data. For example, when, by performing the analysis of the image data, determining that the user is taking a meal, the vision processing unit 110 generates local context data “Label_A.”.

(ST4) The vision processing unit 110 stores the generated local context data in the local context buffer 121 of the buffer processing unit 120. The vision processing unit 110 notifies the power-supply control unit 141 that the local context data is generated and the storage in the local context buffer 121 is completed. The power-supply control unit 141 receives the notification of the vision processing unit 110.

(ST5) The power-supply control unit 141 turns off the vision processing unit 110 and turns on the communication processing unit 130. (ST6) The communication processing unit 130 is turned on. The vision processing unit 110 is kept off until being turned on again.

(ST7) The communication processing unit 130 reads out the local context data from the local context buffer 121. (ST8) The communication processing unit 130 transmits the local context data to the home server 300.

(ST9) The communication processing unit 130 confirms that the vision processing is resumable. For example, when receiving a predetermined notification (for example, an acknowledgment notification of the local context data) from the home server 300, the communication processing unit 130 may determine that the vision processing is resumable.

(ST10) The communication processing unit 130 notifies the resumption of the vision processing to the power-supply control unit 141. The power-supply control unit 141 receives the notification of the communication processing unit 130. (ST11) The power-supply control unit 141 turns off the communication processing unit 130 and turns on the vision processing unit 110.

(ST12) The vision processing unit 110 is turned on. The communication processing unit 130 is kept off until being turned on again. In this way, the vision processing unit 110 resumes the vision processing.

A procedure of appliance control in the connected home system including the operation of the, sensor device 100 explained above is explained. In the following explanation, local context data and global context data are sometimes respectively abbreviated as “local context” and “global context” in the figures.

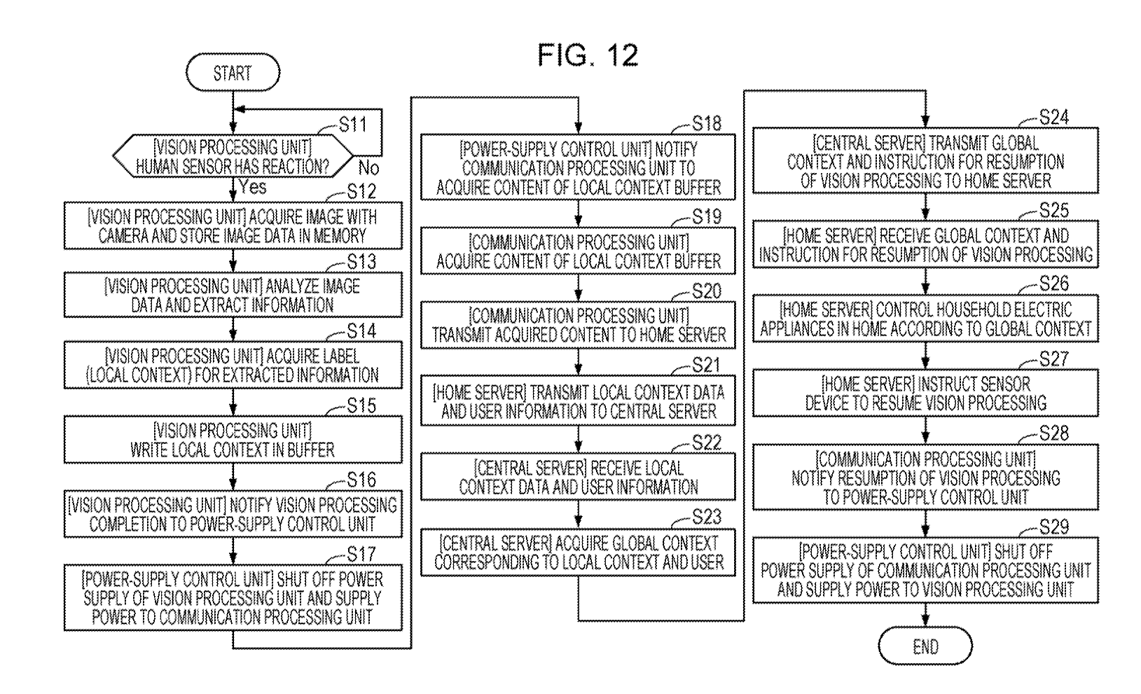

FIG. 12 is a flowchart illustrating an example of appliance control in the third embodiment. In the following explanation, processing illustrated in FIG. 12 is explained below according to step numbers. At a stage when step S11 explained below is executed, the vision processing unit 110 is in a turned-on state and the communication processing unit 130 is in a turned-off state.

(S11) The vision processing unit 110 determines whether the human sensor 113 has reaction. When the human sensor 113 has reaction, the vision processing, unit 110 advances the processing to step S12. When the human sensor 113 has no reaction, the vision processing unit 110 stays on standby until reaction by the human sensor 113 is detected (advances the processing to step S11).

(S12) The vision processing unit 110 acquires an image with the camera 114 and stores image data in the memory 112. (S13) The vision processing unit 110 analyzes the image data stored in the memory 112 and extracts information indicating characteristics and the like of the image.

(S14) The vision processing unit 110 acquires a label (local context data) for the information extracted in step S12. For example, the vision processing unit 110 may store in advance, in a predetermined storage device, a table indicating a correspondence relation between information concerning characteristics extracted from image, data and local context data and acquire the local context data using the table.

(S15) The vision processing unit 110 writes the local context data in the local context buffer 121. (S16) The vision processing unit 110 notifies completion of the vision processing (the generation of the local context data and the storage of the local context data in the local context buffer 121) to the power-supply control unit 141.

(S17) The power-supply control unit 141 shuts off the power supply of the vision processing unit 110 and supplies electric power to the communication processing unit 130. Consequently, the vision processing unit 110 is turned off. The communication processing unit 130 is turned on.

(S18) The power-supply control unit 141 notifies the communication processing unit 130 to acquire content of the local context buffer 121. (S19) The communication processing unit 130 acquires the content of the local context buffer 121 according to the notification from the power-supply control unit 141.

(S20) The communication processing unit 130 transmits the content (the local context data) acquired in step S19 to the home server 300. (S21) The home server 300 receives the local context data transmitted by the communication processing unit 130. The home server 300 transmits the received local context data and user information to the central server 500.

(S22) The central server 500 receives the local context data and the user information. (S23) The central server 500 selects, out of the plurality of context conversion tables stored in the storing unit 510, the context conversion table 511 corresponding to the user information received in step S22. The central server 500 refers to the selected context conversion table 511, global context data corresponding to the local context data received in step S22.

(S24) The central server 500 transmits the global context data and a resumption instruction for the vision processing to the home server 300. (S25) The home server 300 receives the global context data and the resumption instruction for the vision processing.

(S26) The home server 300 controls the household electric appliances 600 and 700 in the house according to the global context data. (S27) The home server 300 instructs the sensor device 100 to resume the vision processing.

(S28) When receiving the instruction in step S27, the communication processing unit 130 notifies the resumption of the vision processing to the power-supply control unit 141. (S29) The power-supply control unit 141 shuts off the power supply to the communication processing unit 130 and supplies electric power to the vision processing unit 110. Consequently, the communication processing unit 130 is turned off. The vision processing unit 110 is turned on. The vision processing unit 110 resumes the vision processing.

Note that, in step S23, the context-generation processing unit 530 of the central server 500 detects an abnormality of the sensor device 100 according to a reception state of content not included in the context conversion table 511 (the list of contents allowed as local context data). For example, the contents allowed as local context data are contents (“Label_A, “Label_B, and the like) other than “default” of the item of the local context in the context conversion table 511. Specifically, it is conceivable that the context-generation processing unit 530 detects, as an abnormality, for example, non-reception of local context data for a predetermined time or continuous reception of content corresponding to “default” in an unnatural form. In this way, it is possible to detect early, in the central server 500, an abnormality in devices (for example, the vision processing unit 110 and the communication processing unit 130) on the house inner side.

Because the sensor data is converted into the local context data and sent, even if data output to the home server 300 by the sensor device 100 is intercepted, the sensor data may be stopped from being directly accessed.

The vision processing may be resumed by the vision processing unit 110 at timing earlier than step S28. A specific example of a procedure for bringing forward the timing of the resumption of the vision processing is explained below.

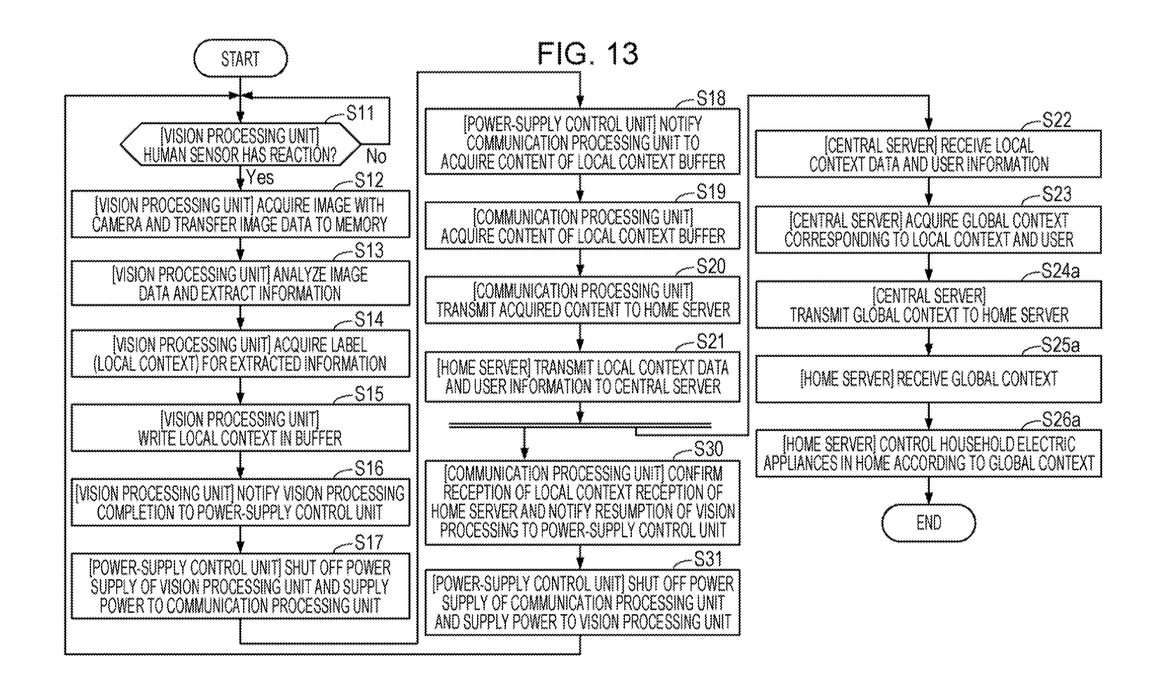

FIG. 13 is a flowchart illustrating another example of the appliance control in the third embodiment. Processing illustrated in FIG. 13 is explained below according to step numbers. In a procedure illustrated in FIG. 13, timing of resumption of the vision processing by the vision processing unit 110 is different from the timing in the procedure illustrated in FIG. 12. Specifically, the procedure illustrated in FIG. 13 is different from the procedure illustrated in FIG. 12 in that steps S24a, S25a, and S26a are executed instead of steps S24, S25, and S26 in FIG. 12, in that steps S27, S28, and S29 are not executed, and in that steps S30 and S31 are further executed. Therefore, the steps different from the steps of the procedure illustrated in FIG. 12 are explained. Explanation of the other steps is omitted. In the procedure illustrated in FIG. 13, procedures in steps S22 to S26a and procedures in steps S30 and S31 are performed in parallel subsequently to the procedure in step S21.

(S24a) The central server 500 transmits the global context data to the home server 300. (S25a) The home server 300 receives the global context data.

(S26a) The home server 300 controls the household electric appliances 600 and 700 in the house according to the global context data. A series of processing by the central server 500 and the home server 300 in steps S22 to S26a ends in step S26a.

(S30) The communication processing unit 130 confirms reception of the local context data of the home server 300 and notifies the resumption of the vision processing to the power-supply control unit 141. For example, by receiving, from the home server 300, an acknowledgement response of the local context data transmitted in step S20, the communication processing unit 130 may confirm that the local context data is received by the home server 300.

(S31) The power-supply control unit 141 shuts off the power supply to the communication processing unit 130 and supplies electric power to the vision, processing unit 110. Consequently, the, communication processing unit 130 is turned off. The vision processing unit 110 is turned on. The vision processing unit 110 resumes the vision processing (advances the processing to step S11).

In the connected home system, information leakage, due to an illegal access to the sensor device 100 is a problem. For example, when the sensor device 100 receives an illegal access, it is likely that the sensor data inside the sensor device 100 is accessed.

Therefore, in the sensor device 100, the vision processing unit 110 and the communication processing unit 130 are exclusively turned on by the power-supply control unit 141. Then, first, while the vision processing unit 110 generates local context data based on the sensor data, the sensor device 100 is unable to perform communication using the communication processing unit 130. That is, an access from the network 30 and 40 to the communication processing unit 130 is unable to be performed. Therefore, an illegal access to the sensor device 100 may be stopped. Accordingly, an illegal access to the sensor data and leakage of the sensor data during processing in the vision processing unit 110 may be stopped.

Second, the vision processing unit 110 is unable to be accessed while the communication processing unit 130 transmits the local context data. Therefore, even if the communication processing unit 130 receives an illegal access, an illegal access to data stored in the memory 112 of the vision processing unit 110 may be stopped. Accordingly, leakage of the sensor data input to the vision processing unit 110 may be stopped.

In particular, in the connected home system, data concerning privacy such a sensor data for the user living in the house is treated. Therefore, appropriate protection of the data is requested. This is because, if a life style and the like of the user are known by an outsider, privacy of the user is infringed. It is also likely that data concerning an individual reflected in an image or the like leaks and is illegally used by an outsider. With the sensor device 100, even when such important data concerning the, individual is input, the input data may be appropriately protected. In particular, in a system requested to grasp the behavior of a user for twenty-four hours, it is possible to protect privacy of the user without relying on software processing and even if the system is hacked.

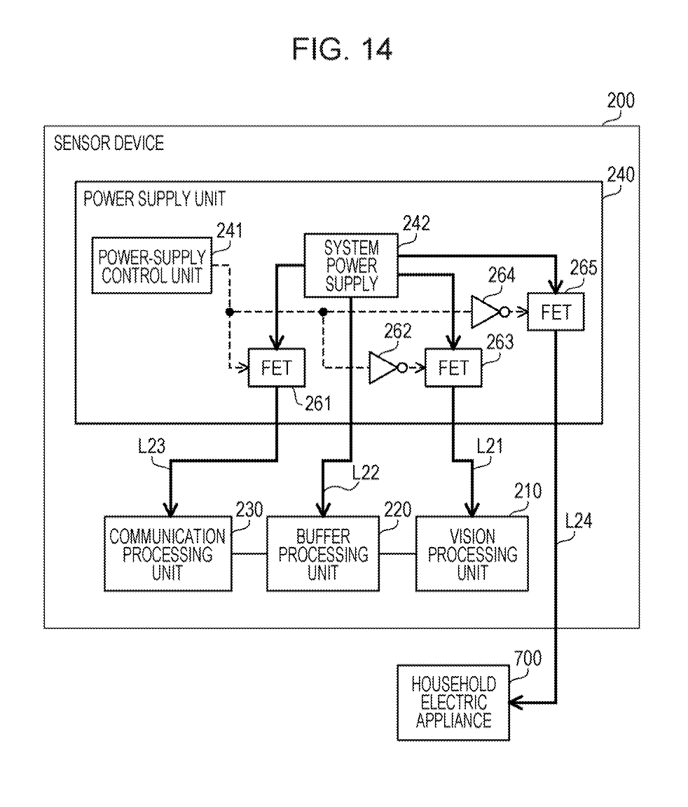

Note that the sensor device 200 may include, in addition to the function of the sensor device 100, a function of turning on/off power supply to a household electric appliance in association with a sensor function. FIG. 14 is a diagram illustrating another example of the power supply unit of the sensor device in the third embodiment. The sensor device 200 includes a vision processing unit 210, a buffer processing unit 220, a communication processing unit 230, and a power supply unit 240. The vision processing unit 210, the buffer processing unit 220, and the communication processing unit 230 perform the same processing as the processing of the components having the same names in the sensor device 100. However, the vision processing unit 210 only has to include a human sensor function and may not include a camera function. The vision processing unit 210 generates local contest data based on sensor data detected by a human sensor.

The power supply unit 240 includes a power-supply control unit 241 and a system power supply 242, The power-supply control unit 241 is realized by a processor such as an FPGA or an ASIC. The power-supply control unit 241 performs the same processing as the processing of the power-supply control unit 141 in the sensor device 100. The system power supply 242 is a power supply of the sensor device 200 and supplies electric power to the household electric appliance 700 as well. A power supply line L21 is a wire for supplying electric power to the vision processing unit 210. A power supply line L22 is a wire for supplying electric power to the buffer processing unit 220. A power supply line L23 is a wire for supplying electric power to the communication processing unit 230. A power supply line L24 is a wire for supplying electric power to the household electric appliance 700.

The power-supply control unit 241 performs not only power supply control for the vision processing unit 210 and the communication processing unit 230 but also power supply control for the household electric appliance 700. Specifically, the power supply unit 240 further includes FETs 261, 263, and 265 and NOT circuits 262 and 264.

The FET 261 is provided on e power supply line L23. A signal from the power-supply control unit 241 is input to the FET 261. When Low is input to the FET 261, electric power is supplied from the system power supply 242 to the communication processing unit 230 through the power supply line L23. When High is input to the FET 261, the power supply line L23 changes to a disconnected state. The power supply from the system power supply 242 to the communication processing unit 230 is interrupted.

The NOT circuits 262 and 264 are respectively provided on signal lines that respectively enter the FETs 263 and 265 from the power-supply control unit 241. The NOT circuit 262 inverts a signal input to the FET 263 from the power-supply control unit 241 such that Low and High are alternately input to the respective FETs 261 and 263. Similarly, the NOT circuit 264 inverts a signal input to the FET 265 from the power-supply control unit 241 such that Low and High are alternately input to the respective FETs 261 and 265. For example, when Low is input to the FET 261 from the power-supply control unit 241, High is input to the FETs 263 and 265. When High is input to the FET 261 from the power-supply control unit 241, Low is input to the FETs 263 and 265.

The FET 263 is provided on the power supply line L21. A signal from the power-supply control unit 241 is input to the FET 263. When Low is input to the FET 263, electric power is supplied from the system power supply 242 to the vision processing unit 210 through the power supply line L21. When High is input to the FET 263, the power supply line L21 changes to a disconnected state. The power supply from the system power supply 242 to the vision processing unit 210 is interrupted.

The FET 265 is provided on the power supply line L24. A signal from the power-supply control, unit 241 is input to the FET 265. When Low is input to the FET 265, electric power is supplied from the system power supply 242 to the household electric appliance 700 through the power supply line L24. When High is input to the FET 265, the power supply line L24 changes to a disconnected state. The power supply from the system power supply 242 to the household electric appliance 700 is interrupted.

As explained above, the power-supply control unit 241 turns on/off the power supply to the household electric appliance 700 as well in association with the power supply to the vision processing unit 210. With the sensor device 200, when the vision processing unit 210 is turned on, the household electric appliance 700 is also turned on and the communication processing unit 230 is turned off. On the other hand, when the vision processing unit 210 is turned off, the household electric appliance 700 is also turned off and the communication processing unit 230 is turned on.

In this way, when the communication processing unit 230 is turned on, the household electric appliance 700 is also turned off. Consequently, it is possible to realize failsafe operation. For example, when the communication processing unit 230 is illegally accessed, it is likely that the household electric appliance 700 is also illegally accessed and illegally operated. As the household electric appliance 700, there is a household electric appliance including function of emitting heat o discharging water. When the household electric appliance 700 is illegally operated, it is likely that the user and the house are damaged. Therefore, when the communication processing unit 230 is turned on, the power supply to the household electric appliance 700 is also shut off. Consequently it is possible to stop the household electric appliance 700 from being illegally operated to damage the user and the house of the user.

### Fourth Embodiment

A fourth embodiment is explained below. Matters different from the matters in the third embodiment explained above are mainly explained. Explanation of matters common to the third embodiment is omitted.

In the connected home system in the third embodiment, when communication is intercepted by an outsider between the sensor device and the home server or between the home server and the central server, it is likely that privacy of the user is infringed. Therefore, the fourth embodiment provides a function for the sensor device to apply scramble processing to local context data and sending, the local context data to the home server. Consequently, even if communication is intercepted between the sensor device and the home server or between the home server and the central server, privacy of the user is stopped from being infringed. A connected home system in the fourth embodiment includes a sensor device 100a and a central server 500a instead of the sensor device 100 and the central server 500 illustrated in the third embodiment.

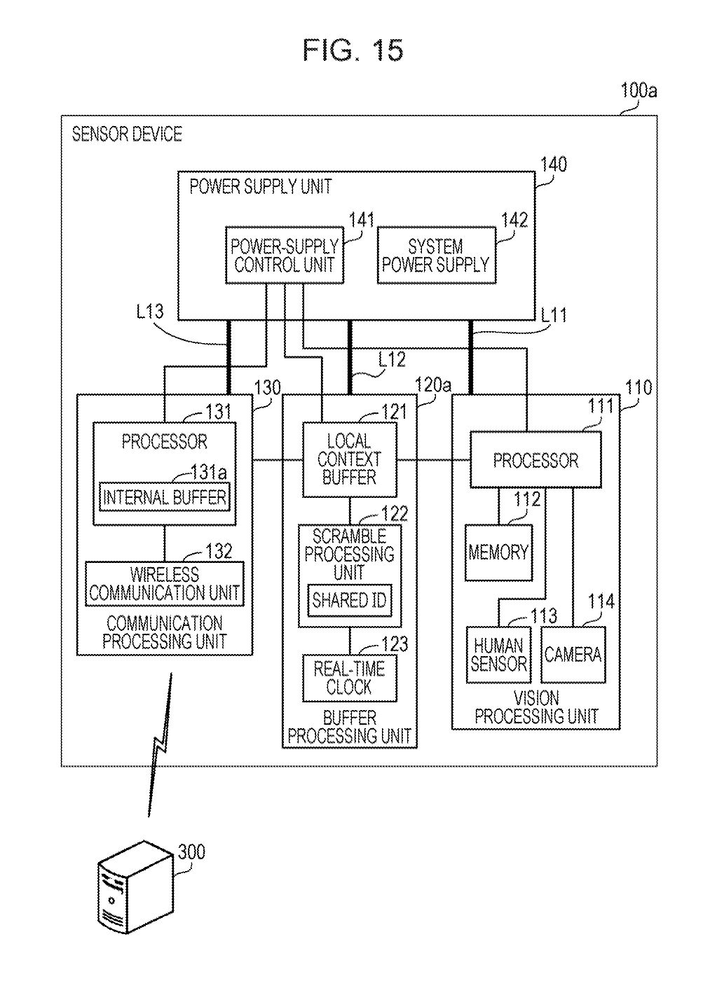

FIG. 15 is a diagram illustrating a hardware example of a sensor device in the fourth embodiment, The sensor device 100a includes the vision processing unit 110, a buffer processing unit 120a, the communication processing unit 130, and the power supply unit 140. The sensor device 100a is different from the sensor device 100 in that the sensor device 100a includes the buffer processing unit 120a instead of the buffer processing unit 120. The operations of the vision processing unit 110, the communication processing unit 130, and the power supply unit 140 other than the buffer processing unit 120a are the same as the operations of the components having the same name in the sensor device 100. However, in the fourth embodiment, the communication processing unit 130 transmits scrambled local context data to the home, server 300.

The buffer processing unit 120a includes the local context buffer 121, a scramble processing unit 122, and a real-time clock 123. The local context buffer 121 stores local context data output by the vision processing unit 110. The local context buffer 121 stores local context data after being applied with scramble processing by the scramble processing unit 122.

The scramble processing unit 122 applies the scramble processing to the local context data stored in the local context buffer 121. For example, the scramble processing unit 122 stores, in a memory on the inside, a shared ID (IDentifier) that the sensor device 100a shares with the central server 500a, For example, the shared ID is information concerning a key issued in advance for each sensor device or for each user. The shared ID is stored in advance in the memory on the inside of the scramble processing unit 122. The scramble processing unit 122 executes the scramble processing for the local context data using the shared ID and the real-time clock 123.

The scramble processing is processing for applying a predetermined arithmetic operation, in which the shared ID and the present time are used, to a bit string of the local context data to create a bit string different from the original bit string. More specifically, the scramble processing unit 122 inputs the string of the local context data, the shared ID, and time information of the real-time clock 123 to a predetermined function and acquires another bit string as an output of the function, The scramble processing unit 122 applies an exclusive OR (EOR) operation to the acquired bit string to obtain a scramble result. In this way, the scramble processing is processing for converting original data into another data with a predetermined arithmetic operation to be unable to be deciphered and may be considered encrypting processing. The “scrambled local context data” may be considered encrypted data or encryption data (first encryption data) as well.

The scramble processing unit 122 stores the scrambled local context data in the local context buffer 121. Note that, when the shared ID is issued for each sensor device, the scramble processing unit 122 gives identification information of the sensor device 100a to the scrambled local context data. However, the identification information of the sensor device it 100a may be given to the scrambled local context data by the home server 300.

The real-time clock 123 provides information indicating the present time to the scramble processing unit 122. The real-time clock 123 is synchronized with a real-time clock included in the central server 500a. For example, the real-time clock 123 may perform synchronization processing by transmitting and receiving a predetermined packet to and from the central server 500a via the communication processing unit 130, the home server 300, and the network 40.

The shared ID used for the scramble of the local context data may be referred to as first shared information as well. The first shared information may include the time information output by the real-time clock 123.

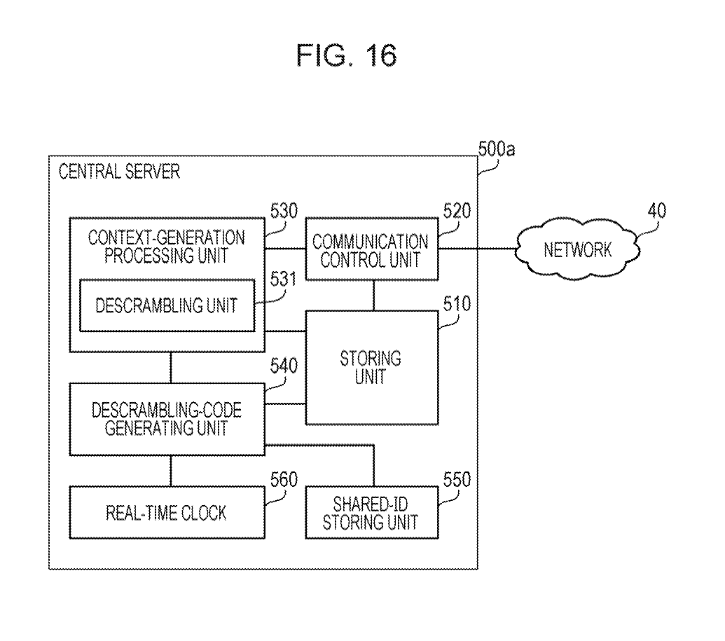

FIG. 16 is a diagram illustrating a function example of a central server in the fourth embodiment. The central server 500a includes the storing unit 510, the communication control unit 520, the context-generation processing unit 530, a descrambling-code generating unit 540, a shared-ID storing unit 550, and a real-time clock 560. The central server 500a is different from the central server 500 in that the context-generation processing unit 530 includes a descrambling unit 531. The central server 500a is different from the central server 500 in that the central server 500a further includes the descrambling-code generating unit 540, the shared-ID storing unit 550, and the real-time clock 560.

The context-generation processing unit 530 descrambles the scrambled local context data using a function of the descrambling unit 531 and restores the local context data. The descrambling unit 531 descrambles the scrambled local context data by applying a predetermined arithmetic operation, in which a descrambling code generated by the descrambling-code generating unit 540 is used, to the scrambled local context data.

The descrambling-code generating unit 540 generates a descrambling code used for the descrambling based on the shared ID stored in the shared-ID storing unit 550 and the present time provided from the real-time dock 560. The descrambling-code generating unit 540 acquires the shared ID used for the generation of the descrambling code from the shared-ID storing unit 550 based on the user information acquired from the context-generation processing unit 530 and the identification information of the sensor device 100a.

The shared-ID storing unit 550 stores the shared ID of each sensor device or each user that the central server 500a shares with the sensor device 100a. When the shared ID is issued for each sensor device, the shared-ID storing unit 550 stores the shared ID in association with identification information of the sensor device. When the shared ID is issued for each user, the shared-ID storing unit 550 stores the shared ID in association with account information of the user.

The real-time dock 560 provides information indicating the present time to the descrambling-code generating unit 540. The real-time dock 560 is synchronized with the real-time dock 123 included in the sensor device 100a.

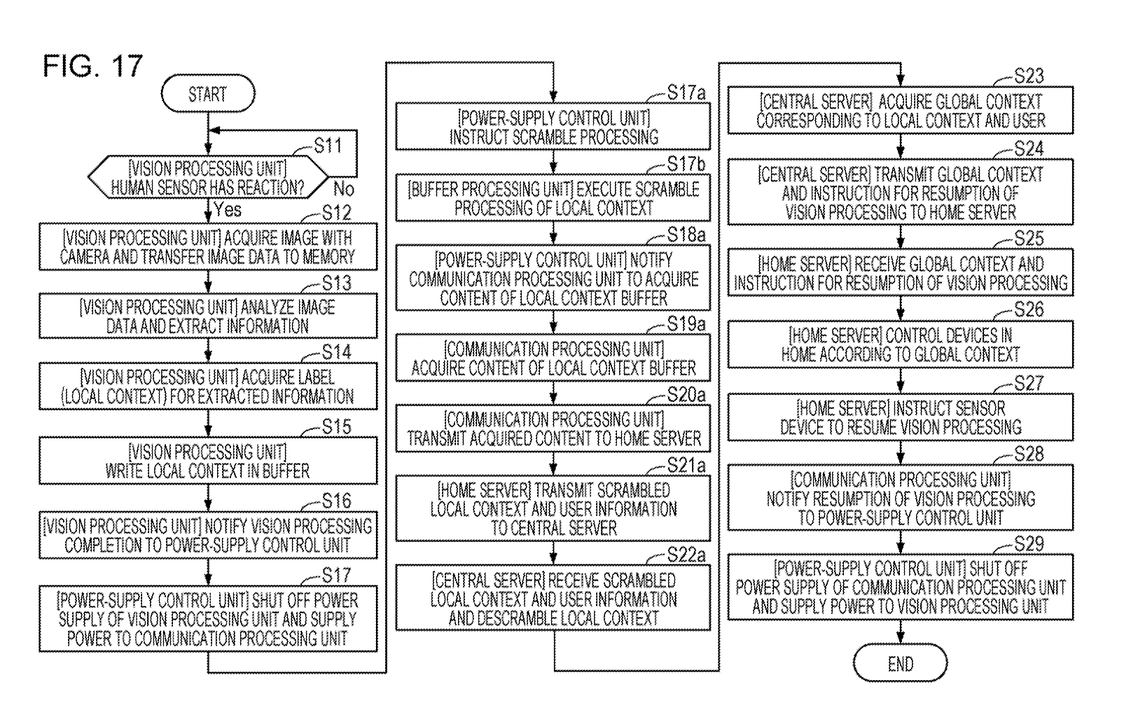

A procedure of appliance control in the connected home system in the fourth embodiment is explained. FIG. 17 is a flowchart illustrating an example of appliance control in the fourth embodiment. Processing illustrated in FIG. 17 is explained below according to step numbers. A procedure illustrated in FIG. 17 is different from the procedure illustrated in FIG. 12 in that steps S17a, S17b, S18a, S19a, S20a, S21a, and S22a are executed instead of steps S18 to S22. Therefore, in the following explanation, steps different from the steps of the procedure illustrated in FIG. 12 are explained. Explanation of the other steps is omitted. In the procedure illustrated in FIG. 17, step S17a is executed subsequently to step S17 and step S23 is executed subsequently to step S22a.

(S17a) The power-supply control unit 141 instructs the buffer processing unit 120a to perform scramble, processing of the, local context data. (S17b) The buffer processing unit 120a executes the scramble processing of the local context data. The buffer processing unit 120a stores the scrambled local context data in the local context buffer 121. When a shared ID used for the scramble processing is issued for each sensor device, the buffer processing unit 120a adds the identification information of the sensor device 100a to the scrambled local context data. The buffer processing unit 120a notifies completion of the scramble processing to the power-supply control unit 141.

(S18a) The power-supply control unit 141 notifies the communication processing unit 130 to acquire content of the local context buffer 121. (S19a) The communication processing unit 130 acquires the content of the local context buffer 121. The content of the local context buffer 121 is specifically the scrambled local context data.

(S20a) The communication processing unit 130 transmits the content acquired in step S19a to the home server 300. (S21a) The home server 300 transmits the scrambled local context data and the user information to the central server 500a.

(S22a) The central server 500a receives the scrambled local context data and the user information and descrambles the scrambled local context data with the function of the descrambling unit 531. As explained above, the descrambling unit 531 may perform the descrambling by the predetermined arithmetic operation in which the descrambling code generated by the descrambling-code generating unit 540 is used. The central server 500a advances the processing to step 523.

In this way, the sensor device 100a applies the scramble processing to the local context data to conceal communication content (the local context data) in a communication path from the sensor device 100a to the central server 500a. Therefore, even if communication is intercepted in the communication path from the sensor device 100a to the central server 500a, privacy of the user may be protected.

### Fifth Embodiment

A fifth embodiment is explained below. Matters different from the matters in the fourth embodiment explained above are mainly explained. Explanation of matters common to the fourth embodiment is omitted.

In the fourth embodiment, the communication content in the communication path of the communication from the sensor device to the central server (so to speak, uplink communication) is concealed. The fifth embodiment provides a function of concealing communication content in a communication path from the central server to the home server (so to speak, downlink communication). A connected home system in the fifth embodiment includes a central server 500b and a home server 300a instead of the central servers 500 and 500a and the home server 300 illustrated in the third and fourth embodiments.

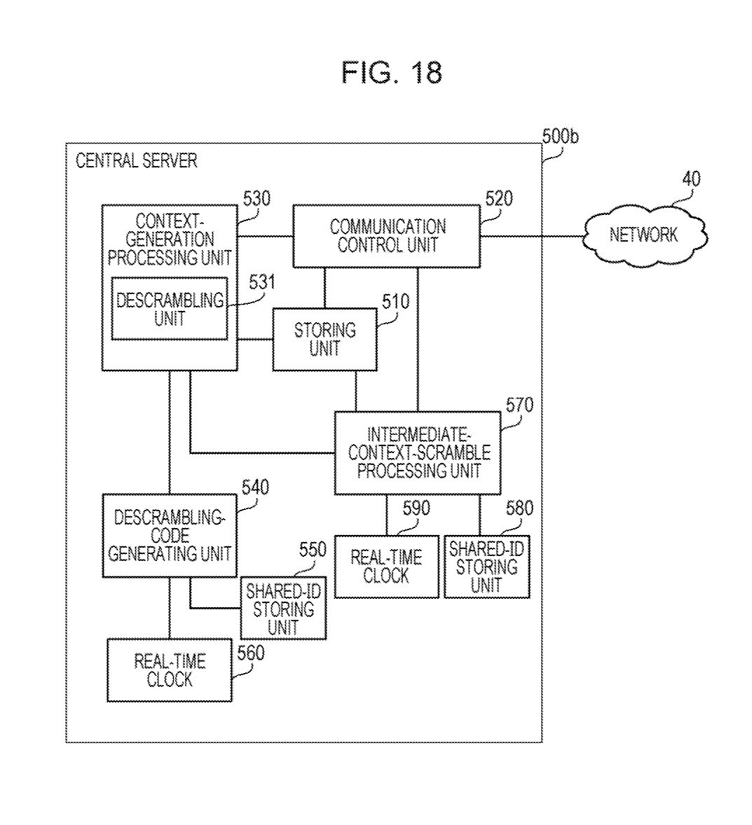

FIG. 18 is a diagram illustrating a function example of a central server in the fifth embodiment, The central server 500b includes the storing unit 510, the communication control unit 520, the context-generation processing unit 530, the descrambling-code generating unit 540, the shared-ID storing unit 550, the real-time clock 560, an intermediate-context-scramble processing unit 570, a shared-ID storing unit 580, and a real-time clock 590. The central server 500b is different from the central server 500a in that the central server 500b further includes the intermediate-context-scramble processing unit 570, the shared-ID storing unit 580, and the real-time clock 590. The storing unit 510 further stores an intermediate context conversion table for converting global context data into intermediate context data.

The intermediate-context-scramble processing unit 570 converts global context data generated by the context-generation processing unit 530 into intermediate context data based on the intermediate context conversion table stored in the storing unit 510.

The intermediate-context-scramble processing unit 570 applies scramble processing to the intermediate context data using a shared ID stored the shared-ID storing unit 580 and time information provided by the real-time dock 590. The intermediate-context-scramble processing unit 570 may use the same arithmetic operation as the arithmetic operation of the scramble processing unit 122 as an arithmetic operation for the scramble processing based on the shared ID and the time information, However, the scramble processing unit 122 and the intermediate-context-scramble processing unit 570 may execute the scramble processing using different arithmetic operations. The intermediate-context-scramble processing unit 570 transmits the scrambled intermediate context data to the home server 300a via the communication control unit 520. The “scrambled intermediate context data” may be considered encrypted data or encryption data (second encryption data).

The shared-ID storing unit 580 stores a shared ID that the central server 500b shares with the home server 300a. For example, the shared ID stored in the shared-ID storing unit 580 is information concerning a key issued in advance to the home server 300a. For example, the central server 500b may manage shared IDs for a respective plurality of home servers. The shared-ID storing unit 580 stores the shared IDs in association with identification information of the home severs.

The real-time clock 590 provides information indicating the present time to the intermediate-context-scramble processing unit 570. The real-time clock 590 is synchronized with a real-time clock of the home server 300a.

The shared ID used for the scramble of the intermediate context data may be referred to as second shared information as well. The second shared information may include the time information output by the real-time clock 590.

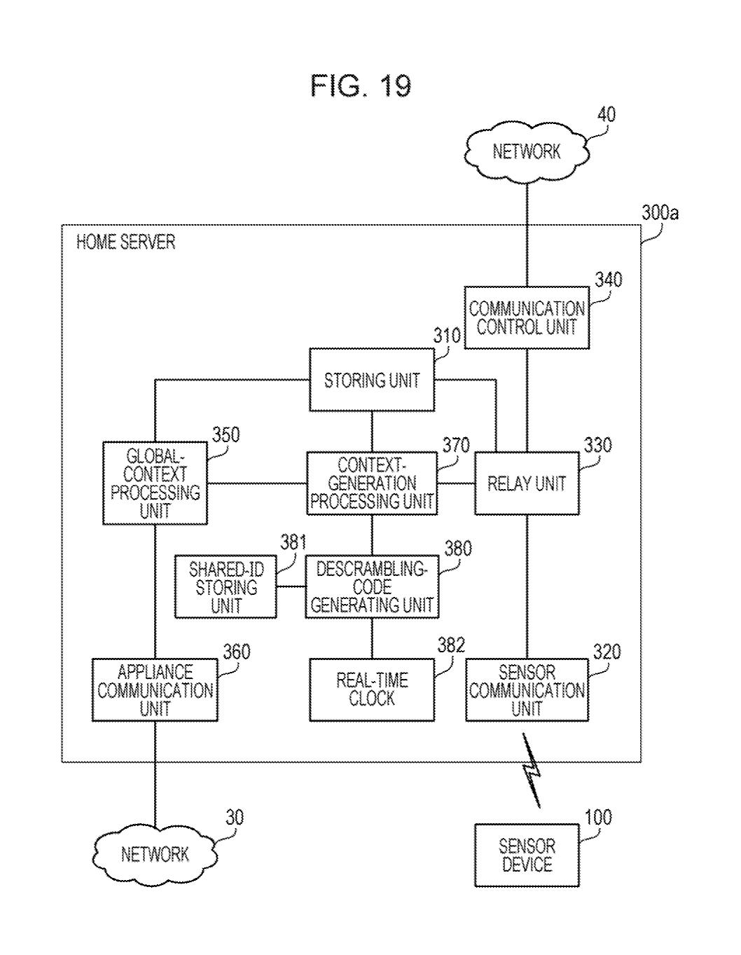

FIG. 19 is a diagram illustrating a function example of a home server in the fifth embodiment, The home server 300a includes the storing unit 310, the sensor communication unit 320, the relay unit 330, the communication control unit 340, the global-context processing unit 350, the appliance communication unit 360, a context-generation processing unit 370, a descrambling-code generating unit 380, a shared-ID storing unit 381, and a real-time clock 382. The home server 300a is different from the home server 300 in that the home server 300a includes the context-generation processing unit 370, the descrambling-code generating unit 380, the shared-ID storing unit 381, and the real-time clock 382. The storing unit 310 further stores an intermediate context conversion table for converting intermediate context data into global context data. When receiving scrambled intermediate context data from the central server 500b, the relay unit 330 passes the scrambled intermediate context data to the context-generation processing unit 370.

The context-generation processing unit 370 descrambles the scrambled intermediate context data using a descrambling code generated by the descrambling-code generating unit 380 and restores the intermediate context data.

The context-generation processing unit 370 generates, based on the intermediate context conversion table stored in the storing unit 310, global context data corresponding to the received intermediate context data. The context-generation processing unit 370 provides the generated global context data to the global-context processing unit 350.

The descrambling-code generating unit 380 generates a descrambling code based on the shared ID stored in the shared-ID storing unit 381 and time information provided by the real-time clock 382 and provides the descrambling code to the context-generation processing unit 370.

The shared-ID storing unit 381 stores a shared ID that the home server 300a shares with the central server 500b. The real-time clock 382 provides information indicating the present time to the descrambling-code generating unit 380. The real-time clock 382 is synchronized with the real clock 590 included in the central server 500b.

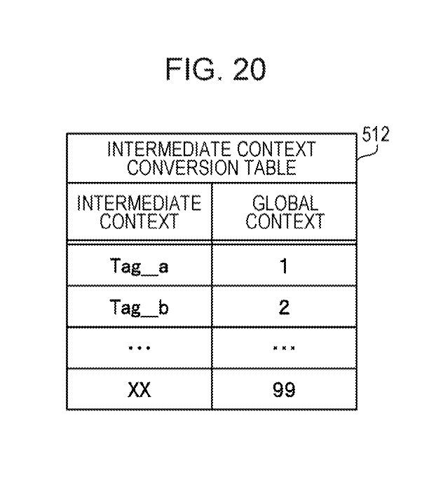

FIG. 20 is a diagram illustrating an example of an intermediate context conversion table in the fifth embodiment. An intermediate context conversion table 512 is stored in advance in the storing unit 510. A duplicate of the intermediate context conversion table 512 is stored in advance in the storing unit 310 as well. The intermediate context conversion table 512 includes items an intermediate context and a global context.

In the item of the intermediate context, content of the intermediate context data is registered. In the item of the global context, content of the global context data is registered. For example, in the intermediate-context conversion table 512, information indicating that the intermediate context is “Tag_a” and the global context is “1” is registered. This indicates that the global context data is set to “1” when the intermediate context data is “Tag_a”. Alternatively, this indicates that the intermediate context data is set to “Tag_A” when the global context data is “1”.

In the intermediate context conversion table 512, global context data is associated with other intermediate context data in the same manner. Note that a record in which the intermediate context is “XX” is also registered in the intermediate context conversion table 512. This record indicates that the global context data is set to “99” when received intermediate context data is “XX”. Alternatively, this record indicates that the intermediate context data is set to “XX” when the global context data is “9”.

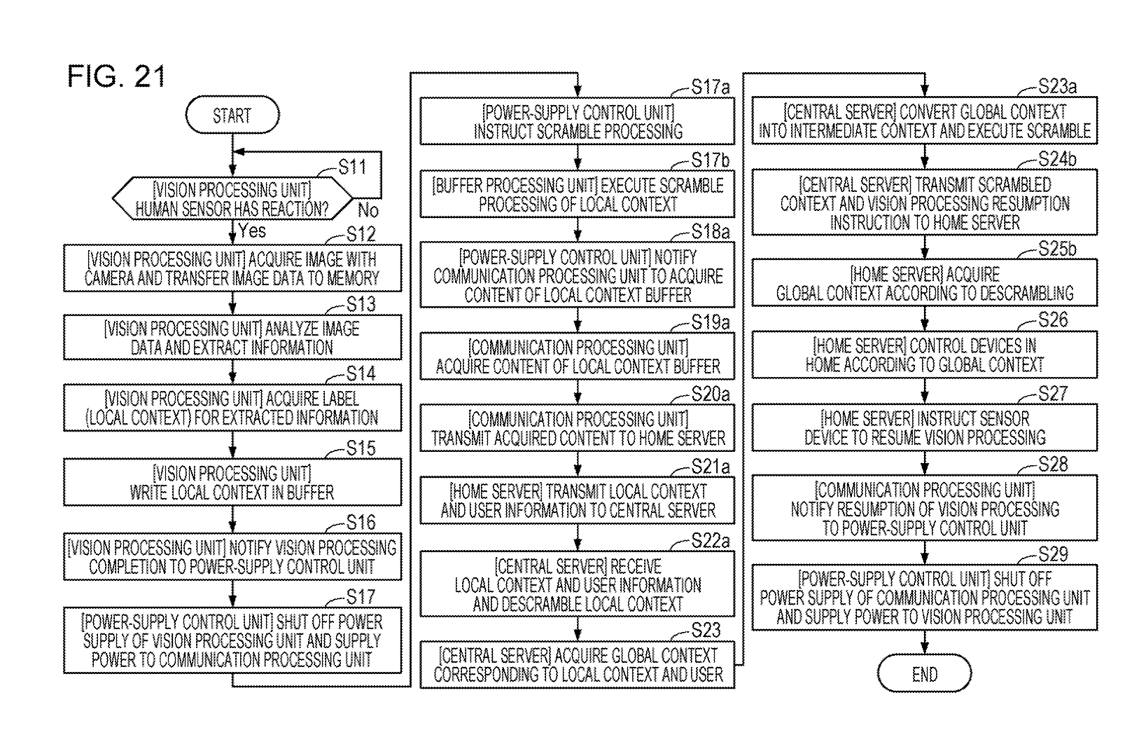

A procedure of appliance control in the connected home system in, the fifth embodiment is explained. FIG. 21 is a flowchart illustrating an example of appliance control in the fifth embodiment. Processing illustrated in FIG. 21 is explained below according to step numbers. A procedure illustrated in FIG. 21 is different from the procedure illustrated in FIG. 17 in that steps S23a, S24b and S25b are executed instead of steps S24 and S25. Therefore, in the following explanation, steps different from the steps of the procedure illustrated in FIG. 17 are explained. Explanation of the other steps is omitted. In the procedure illustrated in FIG. 21, step S23a is executed subsequently to step 523 and step 526 is executed subsequently to step S25b.

(S23a) The central server 500b refers to the intermediate context conversion table 512 stored in the storing unit 510 and converts the global context data into intermediate context data. The central server 500b executes the scramble processing on the intermediate context data and generates scrambled intermediate context data.

(S24b) The central server 500b transmits the scrambled intermediate context data and a vision processing resumption instruction to the home server 300a. (S25b) The home server 300a descrambles the scrambled intermediate context data and, acquires the intermediate context data. The home server 300a refers to the intermediate context conversion table stored in the storing unit 310 and acquires the global context data from the intermediate context data. As explained above, the context-generation processing unit 370 may perform the descrambling with a predetermined arithmetic operation in which the descrambling code generated by the descrambling-code generating unit 380 is used. The home server 300a advances the processing to step 526.

In this way, the central server 500b applies the scramble processing to the intermediate context data to conceal communication content (the intermediate context data) in a communication path from the central server 500b to the home server 300a. Therefore, even if downlink communication is intercepted in the communication path from the central server 500b to the home server 300a, operation of a control target electronic device may be stopped from being estimated. Further, in the fifth embodiment, the central server 500b converts the global context data into the intermediate context data and then applies the scramble processing to the intermediate context data and transmits the intermediate context data to the home server 300a. Therefore, the global context data may be more firmly protected. As a result, reliability for protection of privacy of the user may be improved.

### Sixth Embodiment

A sixth embodiment is explained below. Matters different from the matters in the third embodiment explained above are mainly explained. Explanation of matters common to the third embodiment is omitted.

In the third embodiment, the memory 112 that stores the sensor data is provided in the vision processing unit 110. However, the memory may be provided on the outside of the vision processing unit 110 and set as a target of power supply control. Therefore, in the sixth embodiment, a case is illustrated in which a memory that store sensor data is provided as a device separate from the vision processing unit 110.

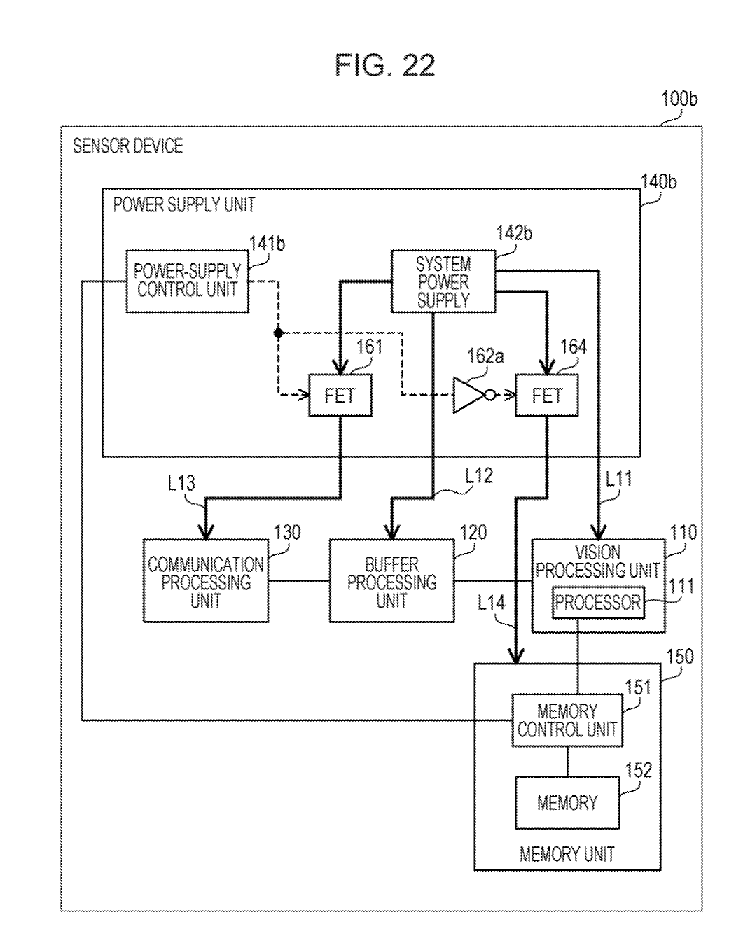

A connected home system in the sixth embodiment includes a sensor device 100b instead of the sensor device 100 illustrated in the third embodiment. FIG. 22 is a diagram illustrating a hardware example of a sensor device in the sixth embodiment. The sensor device 100b includes the vision processing unit 110, the buffer processing unit 120, the communication processing unit 130, a power supply unit 140b, and a memory unit 150. The sensor device 100b is different from the sensor device 100 in that the sensor device 100b includes the power supply unit 140b instead of the power supply unit 140 and further includes the memory unit 150. The operations of the vision processing unit 110, the buffer processing unit 120, and the communication processing unit 130 are the same as the operations of the elements having the same names in the sensor device 100. However, in the sixth embodiment, the processor 111 of the vision processing unit 110 stores sensor data in the memory unit 150.

The power supply unit 140b includes a power-supply control unit 141b and a system power supply 142b. The power-supply control unit 141b is realized by a processor such as an FPGA or an ASIC. The power-supply control unit 141b controls turn-on/off of the communication processing unit 130 and the memory unit 150 from the system power supply 142b. Specifically, the power-supply control unit 141b, exclusively turns on the memory unit 150 and the communication processing unit 130. That is, the power-supply control unit 141b turns off the communication processing unit 130 when turning on the memory unit 150. The power-supply control unit 141b turns off the memory unit 150 when turning on the communication processing unit 130.

The power-supply control unit 141b determines switching timings for the turn-on/off of the communication processing unit 130 and the memory unit 150 according to predetermined notifications from the vision processing unit 110 and the communication processing unit 130. Specifically, when receiving, from the vision processing unit 110, a notification to the effect that a local context is generated and stored in the buffer processing unit 120, the power-supply control unit 141b turns off power supply to the memory unit 150 and turns on power supply to the communication processing unit 130. When receiving, from the communication processing unit 130, a notification to the effect that transmission of the local context is completed, the power-supply control unit 141b turns off the power supply to the communication processing unit 130 and turns on the power supply to the memory unit 150.

The system power supply 142b is a power supply of the sensor device 100b. The system power supply 142b may be a battery like the system power supply 142. The system power supply 142b includes, in addition to the power supply lines L11, L12, and L13, a power supply line L14 for supplying electric power to the memory, unit 150.

The power supply unit 140b further includes FETs 161 and 164 and a NOT circuit 162a in order to realize power supply control by the power-supply control unit 141b. The FET 161 is provided on the power supply line L13, The FET 164 is provided on the power supply line L14. The NOT circuit 162a inverts a signal input to the FET 164 from the power-supply control unit 141b.

In an example of the sensor device 100b, when Low is input to the FET 161 by the power-supply control unit 141b, High obtained by inverting the Low with the NOT circuit 162a is input to the FET 164. Then, the communication processing unit 130 is turned on and the memory unit 150 is turned off. On the other hand, when High is input to the FET 161 by the power-supply control unit 141b, Low obtained by inverting the High with the NOT circuit 162a is input to the FET 164. Then, the communication processing unit 130 is turned off and the memory unit 150 is turned on.

The memory unit 150 includes a memory control unit 151 and a memory 152. The memory control unit 151 stores sensor data output by the processor 111 in the memory 152. The memory 152 is the same storage device as the memory 112.

In the sixth embodiment, the memory unit 150 is an example of the first device 21 in the second embodiment. The vision processing unit 110 is an example of the second device 22 in the second embodiment. The communication processing unit 130 is an example of the third device 23 in the second embodiment. The power-supply control unit 141b is an example of the control device 24 in the second embodiment. When the sensor device 100b is grasped as an aggregate of a plurality of devices in this way, the sensor device 100b may be considered an example of the communication system 20 in the second embodiment. Alternatively, the connected home system in the sixth embodiment may be grasped as one system including the sensor device 100b. The connected home system in the sixth embodiment may be considered an example of the communication system 20 in the second embodiment.

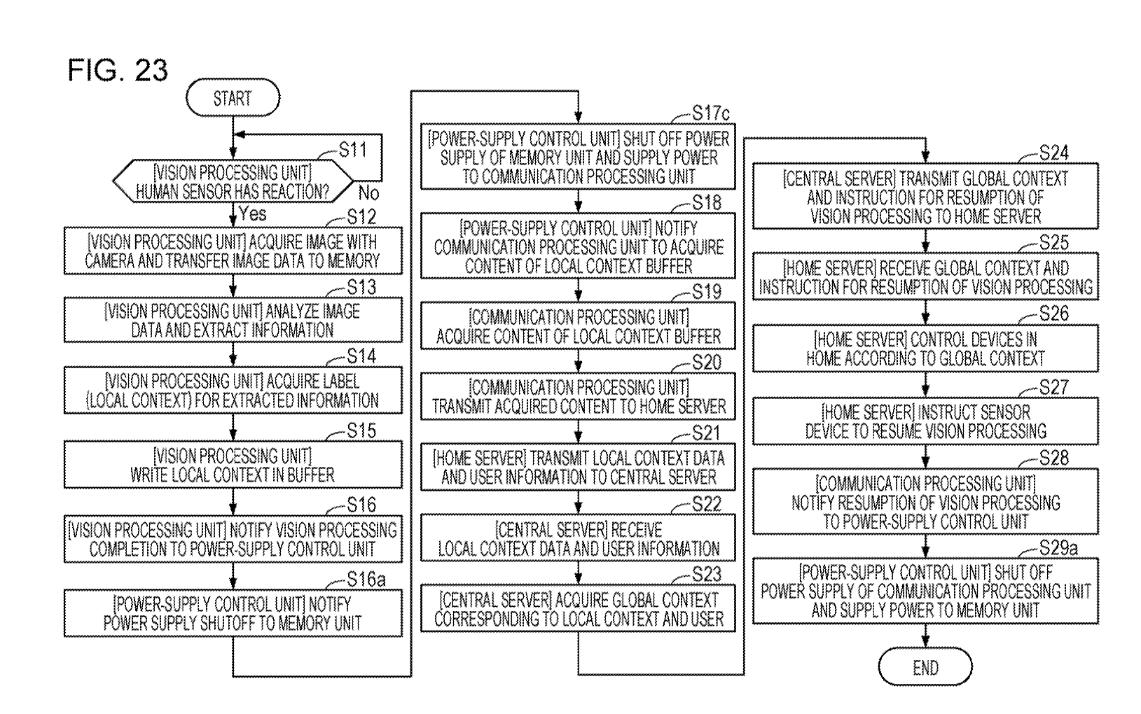

A procedure of appliance control in the connected home system the sixth embodiment is explained. FIG. 23 is a flowchart illustrating an, example of appliance control in the sixth embodiment. Processing illustrated in FIG. 23 is explained below according to step numbers. A procedure illustrated in FIG. 23 is different from the procedure illustrated in FIG. 12 in that steps S16a and S17c are executed instead of step S17 and step S29a is executed instead of step S29. Therefore, in the following explanation, steps different from the steps of the procedure illustrated in FIG. 12 are explained. Explanation of the other steps is omitted. In the procedure illustrated in FIG. 23, step S16a is executed subsequently to step S16 and step S18 is executed subsequently to step S17c. Step S29a is executed subsequently to step S28.

(S16a) The power-supply control unit 141b notifies power supply shutoff to the memory unit 150. (S17c) The power-supply control unit 141b shuts off the power supply to the memory unit 150 and supplies electric power to the communication processing unit 130. Consequently, the memory unit 150 is turned off. The communication processing unit 130 is turned on. The power-supply control unit 141b advances the processing to step S18.

(S29a) The power-supply control unit 141b shuts off the power supply to the communication processing unit 130 and supplies electric power to the memory unit 150. Consequently, the communication processing unit 130 is turned off. The memory unit 150 is turned on. The vision processing unit 110 resumes the vision processing.

In this way, the sensor device 100b exclusively turns on the memory unit 150 and the communication processing unit 130 with the power-supply control unit 141b. Then, the home server 300 is unable to be accessed via the communication processing unit 130 while the vision processing unit 110 generates local context data based on the sensor data. That is, the communication processing unit 130 is unable to be accessed from the outside. Therefore, an illegal access to, the sensor device 100b including the memory unit 150 may be stopped. Leakage of the sensor data stored in the memory unit 150 may be stopped.

Further, the memory unit 150 is unable to be accessed while the communication processing unit 130 transmits the local context data. Therefore, even if the sensor device 100b receives an illegal access via the communication processing unit 130, the sensor data stored in the memory unit 150 may be unable to be accessed. Accordingly, leakage of the sensor data may be stopped.

In particular, when data concerning privacy such a sensor data for the user living in the house is treated, appropriate protection of the data is requested. This is because, if a life style and the like of the user are known by an outsider, privacy of the user is infringed. It is also likely that data concerning an individual reflected in an image or the like leaks and is illegally used by an outsider. By using the connected home system in the sixth embodiment, such important data concerning the individual may be appropriately protected.

### Seventh Embodiment

A seventh embodiment is explained below. Matters different from the matters in the third embodiment explained above are mainly explained. Explanation of matters common to the third embodiment is omitted.

In the sensor device 100 illustrated in the third embodiment, the power-supply control unit 141 exclusively turns on the vision processing unit 110 and the communication processing unit 130. Therefore, the vision processing unit 110 is unable to be accessed when the communication processing unit 130 is communicable.

On the other hand, it is also conceivable to, when the sensor device 100 is hacked, while alternately turning on the vision processing unit 110 and the communication processing unit 130, cut sensor data acquired by the vision processing unit 110 into small pieces and cause the communication processing unit 130 to transmit the sensor data little by little. For example, it is also conceivable to divide image data in a room generated by the camera 114 into a plurality of portions and, while alternately turning on the vision processing unit 110 and the communication processing unit 130, cause the communication processing unit 130 to transmit the image data in units of the portions via the buffer processing unit 120. In this case, for example, it is also likely that an illegally transmitted plurality of portions are combined and the image data in the room is restored.

Therefore, the seventh embodiment provides a function of stopping sensor data from being sequentially transmitted on a non-real-time basis even if the sensor device is hacked in this way is provided. A connected home system in the seventh embodiment includes a sensor device 100c instead of the sensor device 100 illustrated in the third embodiment.

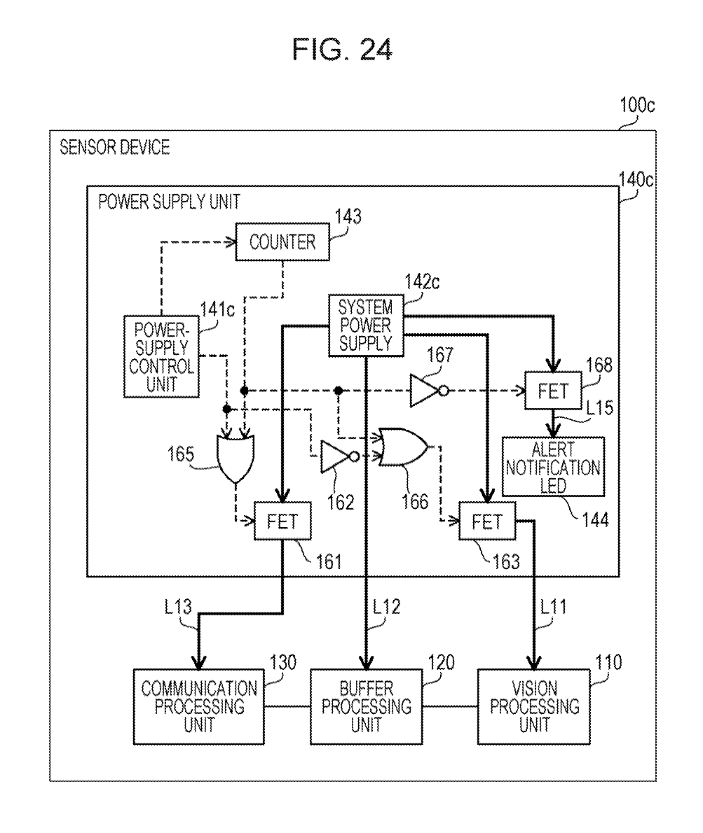

FIG. 24 is a diagram illustrating an example of a power supply unit of a sensor device in the seventh embodiment The sensor device 100c includes the vision processing unit 110, the buffer processing unit 120, the communication processing unit 130, and a power supply unit 140c. The sensor device 100c is different from the sensor device 100 in that the sensor device 100c includes the power supply unit 140c instead of the power supply unit 140. The operations of the vision processing unit 110, the buffer processing unit 120, and the communication processing unit 130 are the same as the operations of the components having the same names in the sensor device 100.

The power supply unit 140c includes a power-supply control unit 141c, a system power supply 142c, a counter 143, and an alert notification LED (Light Emitting Diode) 144. The power-supply control unit 141c is realized by a processor such as an FPGA or an ASIC. The power-supply control unit 141c controls turn-on/off of the vision processing unit 110, the communication processing unit 130, and the alert notification LED 144 from the system power supply 142c. Specifically, the power-supply control unit 141c exclusively turns on the vision processing unit 110 and the communication processing unit 130. After switching the turn-on/off of both of the vision processing unit 110 and the communication processing unit 130, the power-supply control unit 141c outputs a signal to the effect that the switching is performed to the counter 143. Further, the power-supply control unit 141c performs, according to a counter value in a predetermined period of the counter 143, control for turning off the vision processing unit 110 and the communication processing unit 130 and turning on the alert notification LED 144.

The system power supply 142c is a power supply of the sensor device 100c. As explained above, the power supply lines L11, L12, and L13 are the wires for respectively supplying electric power to the vision processing unit 110, the buffer processing unit 120, and the communication processing unit 130. A power supply line L15 is a wire for supplying electric power to the alert notification LED 144.

The counter 143 counts the number of times (referred to as number of times of exclusive control) the switching of the turn-on/off of the vision processing unit 110 and the communication processing unit 130 is performed by the power-supply control unit 141c. A counter value of the counter 143 is used for the power supply control of the vision processing unit 110, the communication processing unit 130, and the alert notification LED 144 by the power-supply control unit 141c. When the number of times of exclusive control in a predetermined period reaches a threshold, the counter 143 outputs, according to the control by the power-supply control unit 141c, a signal for turning off the vision processing unit 110 and the communication processing unit 130 and turning on the alert notification LED 144.

The alert notification LED 144 emits light when being turned on a visually notifies the user that an abnormality has occurred in the sensor device 100c. To perform the power supply control explained above by the power-supply control unit 141c, the, power supply unit 140c further includes FETs 161, 163, and 168, NOT circuits 162 and 167, and OR circuits 165 and 166.

A signal output from the OR circuit 165 is input to the FET 161. Signals respectively output from the power-supply control unit 141c and the counter 143 are input to the OR circuit 165. The counter 143 outputs Low at normal time (while the number of times of exclusive control in the predetermined period is smaller than the threshold). The counter 143 outputs High after abnormality detection (after the number of times of exclusive control in the predetermined period reaches the threshold).

A signal from the power-supply control unit 141c is input to the NOT circuit 162. An output of the NOT circuit 162 becomes an input to the OR circuit 166. Another input to the OR circuit 166 is a signal output by the counter 143. A signal output from the OR circuit 166 is input to the FET 163. A signal from the counter 143 is input to the NOT circuit 167. A signal output from the NOT circuit 167 is input to the FET 168. Like the FETs 161 and 163, the FET 168 connects the power supply line L15 when Low is input as the output of the NOT circuit 167 and disconnect the power supply line L15 when High is input as the output of the NOT circuit 167.

Then, because the counter 143 outputs Low at the normal time, as in the third embodiment, the power-supply control unit 141c exclusively turns on the power supply to the vision processing unit 110 and the communication processing unit 130. At this time, a signal of High obtained by inverting a signal of Low from the counter 143 with the NOT circuit 167 is input to the FET 168. Therefore, the alert notification LED 144 is turned off.

Note that, after the abnormality detection, the counter 143 outputs High. Therefore, High is input to both of the FETS 161 and 163. Both of the vision, processing unit 110 and the communication processing unit 130 are turned off. At this time, a signal of High output from the counter 143 is inverted by the NOT circuit 167. Therefore, a signal of Low is input to the FET 168. The alert notification LED 144 is turned on.

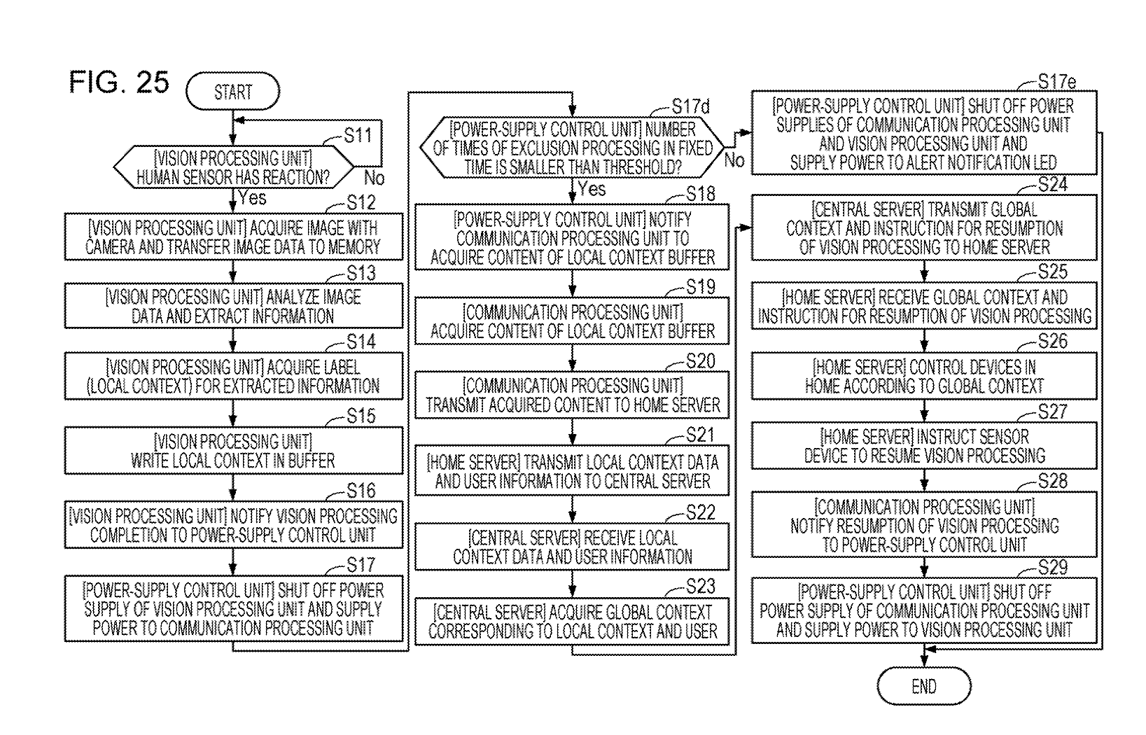

A procedure of appliance control in the connected home system in the seventh embodiment is explained. FIG. 25 is a flowchart illustrating an example of appliance control in the seventh embodiment. Processing illustrated in FIG. 25 is explained below according to step numbers. A procedure illustrated in FIG. 25 is different from the procedure illustrated in FIG. 12 in that steps S17d and S17e are further executed. Therefore, in the following explanation, steps different from the steps of the procedure illustrated in FIG. 12 are explained. Explanation of the other steps is omitted. In the procedure illustrated in FIG. 25, step S17d is executed subsequently to step S17. The procedure proceeds to one of steps S17e and S18 according to determination in step S17d. Note that, at a stage before step S17e is executed, an output signal of the counter 143 is Low.

(S17d) The power-supply control unit 141c determines whether the number of times of exclusive control in a fixed time is smaller than a threshold. When the number of times of exclusive control in the fixed time is smaller than the threshold, the power-supply control unit 141c advances the processing to step S18. When the number of times of exclusive control in the fixed time is equal to or larger than the threshold, the power-supply control unit 141c advances the processing to step S17e. As explained above, the power-supply control unit 141c counts the number of times of exclusive control using the counter 143. For example, the power-supply control unit 141c increments a count value of the counter 143 at timing when the switching of the turn-on/off is performed in step S17 and timing when the switching of the turn-on/off is performed in step S28 (or in one of the timings). The fixed time may be optionally decided according to operation (for example, thirty seconds or one minute). The counter 143 resets the count value retained by the counter 143 to 0 at a cycle of the fixed time. The threshold used in the determination in step S17d may also be optionally decided according to operation (for example, ten times or twenty times).

(S17e) The power-supply control unit 141c shuts of the power supply to the vision processing unit 110 and the communication processing unit 130 and supplies electric power to the alert notification LED 144. Specifically, the power-supply control unit 141c instructs the counter 143 to change the output signal from Low to High. Then, the counter 143 changes the output signal from Low to High. As a result, the power supply to the vision processing unit 110 and the communication processing unit 130 is interrupted. Power supply to the alert notification LED 144 is started. Consequently, the vision processing unit 110 and the communication processing unit 130 are turned off. The alert notification LED 144 is turned on. The power-supply control unit 141c ends the processing.

In this way, the power-supply control unit 141c regards frequent switching of the turn-on/off of the vision processing unit 110 and the communication processing unit 130 as an abnormality and turns off the power supply to both of the vision processing unit 110 and the communication processing unit 130. Consequently, even if the sensor device 100c is hacked, the sensor data is stopped from being sequentially transmitted on a non-real-time basis. Therefore, privacy of the user U1 may be appropriately protected. At this time, occurrence of an abnormality may be notified to the user U1 by feeding electricity to the alert notification LED 144 and causing the alert notification LED 144 to emit light.

### Eighth Embodiment

An eighth embodiment is explained below. Matters different from the matters in the seventh embodiment explained above are mainly explained. Explanation of matters common to the seventh embodiment is omitted.

In the sensor device 100c in the seventh embodiment, when the number of times of exclusive control in the fixed time reaches the threshold, the power supply to both of the vision processing unit 110 and the communication processing unit 130 are shut off. On the other hand, it is also conceivable to continue the power supply to the communication processing unit 130 and transmit notification data to the home server 300 or the central server 500. Then, it is possible to provide a service with further improved security to, for example, notify the abnormality to a security company via, for example, the home server 300 or the central server 500 and perform abnormality check by a guard or the like.

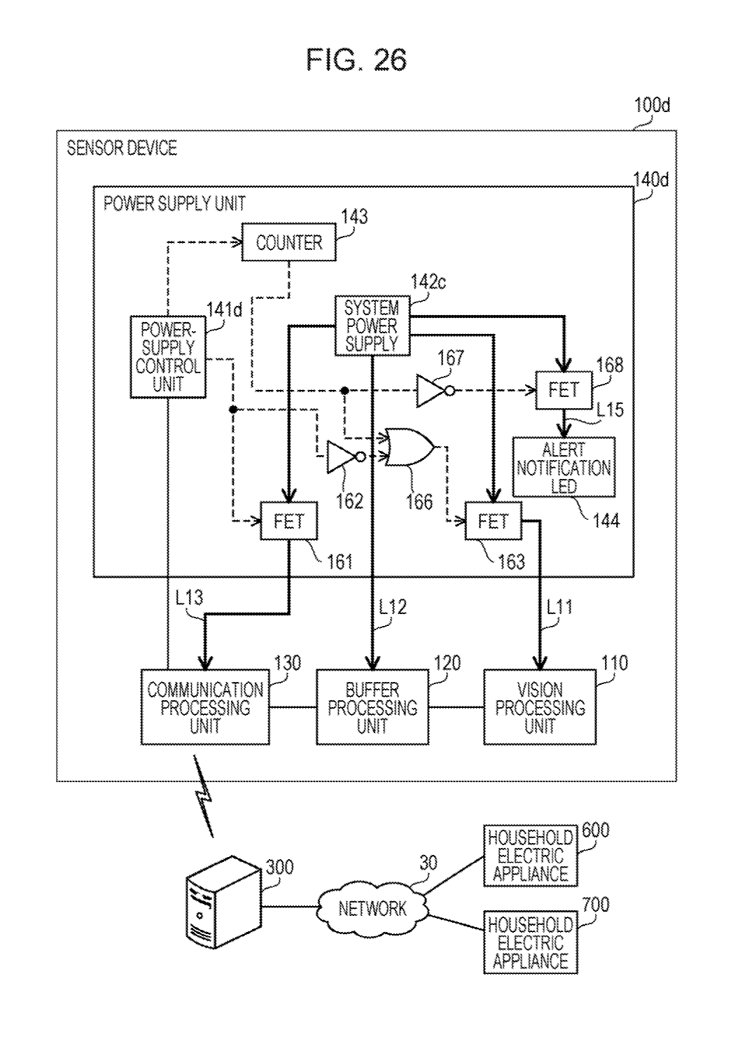

A connected home system in the eighth embodiment includes a sensor device 100d instead of the sensor device 100c illustrated in the seventh embodiment. FIG. 26 is a diagram illustrating a power supply unit of a sensor device in the eighth embodiment. The sensor device 100d includes the vision processing unit 110, the buffer processing unit 120, the communication processing unit 130, and a power supply unit 140d. The operations of the vision processing unit 110, the buffer processing unit 120, and the communication processing unit 130 are the same as the operations of the components having the same names in the sensor device 100 and the sensor device 100c. However, after abnormality detection by the power supply unit 140d, the communication processing unit 130 transmits notification data for notifying an abnormality to the home server 300 or the central server 500.

The power supply unit 140d includes a power-supply control unit 141d, the system power supply 142c, the counter 143, and the alert notification LED 144. The power supply unit 140d is different from the power supply unit 140c in that the power supply unit 140d includes the power-supply control unit 141d instead of the power-supply control unit 141c. The power-supply control unit 141d is realized by a processor such as an FPGA or an ASIC. A basic function of the power-supply control unit 141d is the same as the basic function of the power-supply control unit 141c.

Further, the power supply unit 140d includes the FETs 161, 163, and 168, the NOT circuits 162 and 167, and the OR circuit 166 in order to realize power supply control by the power supply control unit 141d. However, the Power supply unit 140d does not include the OR circuit 165. A relation of inputs and outputs of signals of the FETs 161, 163, and 168, the NOT circuits 162 and 167, and the OR circuit 166 is substantially the same as the relation in the power supply unit 140c. However, the power supply unit 140d is different from the power supply unit 140c in that an output signal of the power-supply control unit 141d is directly input to the FET 161.

That is, after the abnormality detection, the counter 143 outputs High to forcibly turn off only the vision processing unit 110. A turned-on state of the communication processing unit 130 is maintained (at this time, the alert notification LED 144 is tuned on). Then, after the abnormality detection, the power-supply control unit 141d may instruct the communication processing unit 130 to transmit notification data to the home server 300 and the central server 500.

Consequently, it is possible to provide a service with further improved security to, for example, notify the abnormality to a security company via, for example, the home server 300 or the central server 500 and perform abnormality check by a guard or the like.

At this time, the home server 300 may control the power supply to the household electric appliances 600 and 700 to be turned off according to the notification data. Then, when an abnormality occurs in the sensor device 100d, power supply to the household electric appliances (the household electric appliances 600 and 700 and the like) incidental to the sensor device 100d are also shut off. Consequently, it is possible to realize failsafe operation. For example, when an abnormality such as hacking of the sensor device 100d occurs, it is likely that a household electric appliance for controlling a water heater, a gas stove, and the like is illegally operated to damage the user U1 and the house. Therefore, when the abnormality occurs, power supply to the household electric appliance for controlling the water heater, the gas stove, and the like is also shut off. Consequently the damage to the user U1 and the house may be stopped.

### Ninth Embodiment

A ninth embodiment is explained below. Matters different from the matters in the seventh and eighth embodiments explained above are mainly explained. Explanation of matters common to the seventh and eighth embodiments is omitted.

It is explained that, in the connected home system in the eighth embodiment, the power supply to the household electric appliances 600 and 700 and the like may be shut off by the home server 300 that receives the notification data. On the other hand, it is conceivable that the notification data is unable to be appropriately transmitted if the sensor device 100d has an abnormality. For example, when the sensor device 100d is hacked, following expansion of damage sometime may be stopped if the communication processing unit 130 is turned off. Therefore, the ninth embodiment provides a function for a power supply unit of a sensor device and a home server to appropriately turn off a household electric appliance not via communication by the communication processing unit 130 when an abnormality occurs.

A connected home system in the ninth embodiment includes a sensor device 100e and a home server 300c instead of the sensor device 100d and the home server 300 illustrated in the eighth embodiment.

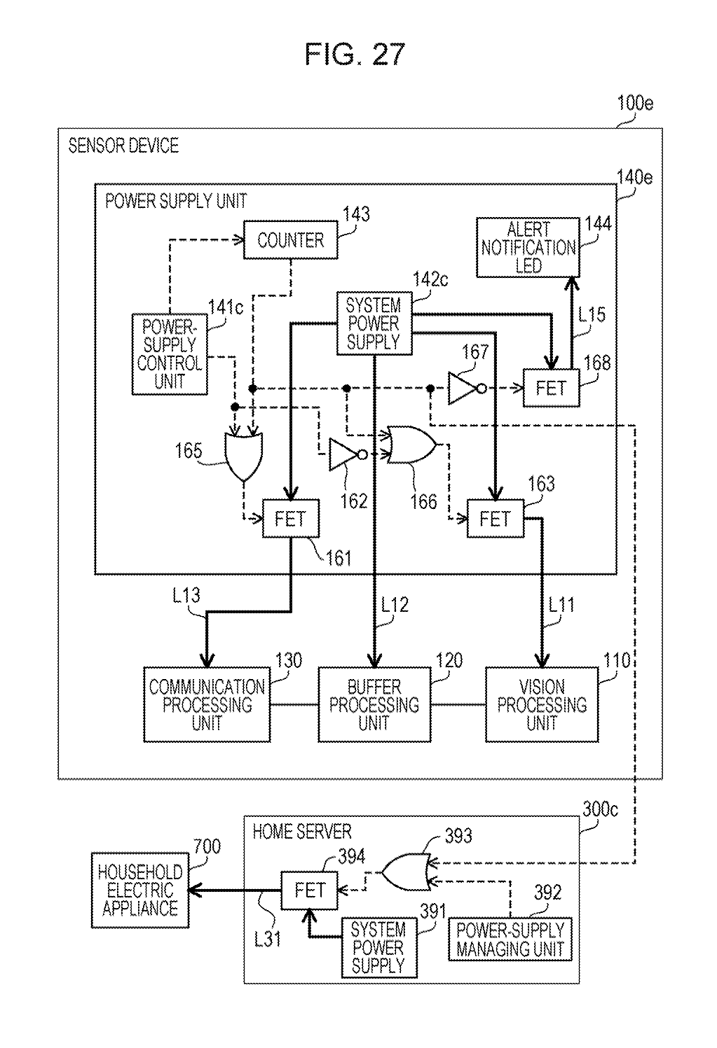

FIG. 27 is a diagram illustrating a hardware example in the ninth embodiment. The sensor device 100e includes the vision processing unit 110, the buffer processing unit 120, the communication processing unit 130, and a power supply unit 140e. The sensor device 100e is different from the sensor device 100d in that the sensor device 100e includes the power supply unit 140e instead of the power supply unit 140d. The operations of the vision processing unit 110, the buffer processing unit 120, and the communication processing unit 130 are the same as the operations of the components having the same names in the sensor device 100 and the sensor device 100d.

The power supply unit 140e includes the power-supply control unit 141c, the system power supply 142c, the counter 143, and the alert notification LED 144. Basic operations of power-supply control unit 141c, the system power supply 142c, the counter 143, and the alert notification LED 144 are the same as the basic operations of the components having the same names in the power supply unit 140c. Like the power supply unit 140c, the power supply unit 140e includes the FETs 161, 163, and 168, the NOT circuits 162 and 167, and the OR circuits 165 and 166 in order to realize power supply control by the power-supply control unit 141c. The power supply unit 140e is different from the power supply unit 140c in that an output signal of the counter 143 is input to the home server 300c as well. The sensor device 100e and the home server 300c are connected by a signal line (a hard wire) for transmitting the signal. For example, the sensor device 100e and the home server 300c respectively include predetermined interfaces for transmitting and receiving the signal through the signal line.

The home server 300c includes a system power supply 391, a power-supply managing unit 392, an OR circuit 393, and an FET 394 in addition to the hardware illustrated in FIG. 6. The system power supply 391 is a power supply of the home server 300c and the household electric appliance 700. A power supply line L31 is a wire for supplying electric power from the system power supply 391 to the household electric appliance 700.

The power-supply managing unit 392 controls power supply to the household electric appliance 700. Specifically, the power-supply managing unit 392 inputs a signal for controlling turn-on/off of the household electric appliance 700 to the OR circuit 393. An output signal of the counter 143 is also input to the OR circuit 393. An output signal of the OR circuit 393 is input to the FET 394. When Low is input to the FET 394, electric power is supplied from the system power supply 391 to the household electric appliance 700 through the power supply line L31. On the other hand, when High is input to the FET 394, the power supply from the system power supply 391 to the household electric appliance 700 is shut off. Therefore, when an abnormality is detected by the power-supply control unit 141c in the sensor device 100e and the output signal of the counter 143 is changed from Low to High, a signal of High is input to the OR circuit 393 as well. A signal input to the FET 394 also changes to High. Therefore, the household electric appliance 700 may be forcibly turned off according to the change in the output signal of the counter 143.

In this way, the sensor device 100e may control the power supply to the household electric appliance 700 to be turned off in terms of hardware according to the abnormality detection. Then, when an abnormality occurs, it is possible to appropriately shut off the power supply to the household electric appliance 700 and realize failsafe operation. In particular, even if the communication processing unit 130 does not transmit notification data to the home server 300c and the central server 500, the household electric appliance 700 may be turned off. Therefore, security for the user U1 and the house during abnormality occurrence may be further improved.

### Tenth Embodiment

A tenth embodiment is explained below. Matters different from the matters in the third embodiment explained above are mainly explained. Explanation of matters common to the third embodiment is omitted.

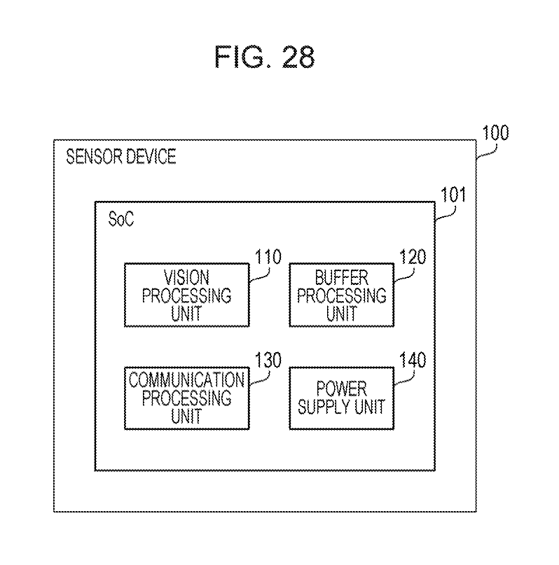

FIG. 28 is a diagram illustrating a hardware example of a sensor device in the tenth embodiment. The buffer processing unit 120, the communication processing unit 130, and the power supply unit 140 in the sensor device 100 may be incorporated in an SoC 101 (in this case, the vision processing unit 110 is provided on the outside of the SoC 101). Alternatively, the SoC 101 may further include the vision processing unit 110 (a portion excluding the human sensor 113 and the camera 114). For example, the SoC 101 is a semiconductor chip including the vision processing unit 110 (the portion excluding the human sensor 113 and the camera 114), the buffer processing, unit 120, the communication processing unit 130, and the power supply unit 140. In this way, the main functions of the sensor device 100 are implemented by the SoC 101. Consequently, marketability of a system product implemented with the functions may be improved. The system product may be easily incorporated in the sensor device 100 and used. Similarly, the units illustrated in the sensor devices 100a, 100b, 100c, 100d, and 100e and the sensor device 200 may be implemented by SoCs.

The above explanation simply indicates the principle of the present invention. Further, a large number of modifications and changes are possible for those skilled in the art. The present invention is not limited to the accurate configurations and the application examples illustrated and explained above. All modifications and equivalents corresponding to the configurations and the application examples are regarded as being within the scope of the present invention by the appended claims and equivalents of the claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication system comprising:
a first device including a first memory for storing first data, and a processor configured to generate second data according to the first data and store the second data in a second memory;
a second device including a communication interface configured to transmit the second data stored in the second memory to a first server; and
a control device including a processor configured to exclusively turn on the first device and the second device.

2. The communication system of claim 1, wherein the first data is data generated by a sensor device for observing a physical phenomenon around the sensor device.

3. The communication system of claim 2, wherein the first data is image data generated by the sensor device.

4. The communication system of claim 1, wherein the control device turns on, when turning on the first device, an electronic device connected to a network to which the first server belongs and turns off the appliance when turning off the first device.

5. The communication system of claim 1, wherein the control device turns off both of the first device and the second device according to a number of times of switching of power supply per a predetermined time to the first device and the second device.

6. The communication system of claim 1, wherein the control device turns off, according to a number times of switching of a power supply per a predetermined time to the first device and the second device, both of the first device and an appliance connected to a network to which the first server belongs.

7. The communication system of claim 1, further comprising:
the first server; and
a second server configured to receive the second data via the first server, convert the second data into third data, and transmit the third data, wherein
the first server receives the third data and controls, according to the third data, an appliance connected to a network to which the first server belongs.

8. The communication system of claim 7, wherein the second server retains a list of contents allowed as the second data and detects an abnormality of the first device and the second device according to a reception state of content not included in the list.

9. The communication system of claim 7, wherein
the second device transmits first encryption data, which is a result obtained by encrypting the second data using first shared information shared with the second server by a buffer processing unit including the second memory, and
when receiving the first encryption data via the first server, the second server restores the second data using the first shared information.

10. The communication system of claim 9, wherein
the second server transmits second encryption data obtained by encrypting the third data using second shared information that the second server shares with the first server, and
when receiving the second encryption data, the first serve restores the third data using the second shared information.

11. The communication system of claim 1, wherein the second device and the control device are incorporated in a system on a chip.

12. A communication system comprising:
a first device including a first memory for storing input first data;
a second device configured to generate second data according to the first data stored in the first memory and store the second data in a second memory;
a third device configured to transmit the second data stored in the second memory to a first server; and
a control device configured to exclusively u n on the first device and the third device.

13. A connected home system comprising:
a server; and
a sensor including
a buffer processing unit including a buffer storage,
a vision processing unit, when powered on, configured to capture image data, generate local context data from the image data, and store the local context data in the buffer storage,
a communication processing unit, when powered on, configured to access the local context data stored in the buffer storage and transmit the local context data to the server, and
a power supply unit configured to switch power supplied to the vision processing unit and the communication processing unit so that only one of the vision processing unit and the communication processing unit is powered on at the same time.

14. The connected home system according to claim 13, wherein the local context data is generated by analyzing the image data, extracting characteristic information from the image data, and comparing the extracted characteristic information to characteristic information stored in a table indicating a correspondence relation between information concerning characteristics extracted from image data.

15. The connected home system according to claim 13, wherein the power supply unit switches power from the vision processing unit to the communication processing unit when the power supply unit receives a notification from the vision processing unit indicating that local context data is stored in the buffer storage.

16. The connected home system according to claim 13, wherein the buffer processing unit further includes a scramble processing unit configured to execute a scramble processing on the local context data.
